(19) United States
(12) Patent Application Publication
(10) Pub. No.: US 2023/0166776 A1
(43) Pub. Date: Jun. 1, 2023

(54) AIRDOCK HARD CAPTURE

(71) Applicant: HYPERLOOP TECHNOLOGIES, INC., Los Angeles, CA (US)

(72) Inventors: Jett FERM, Pasadena, CA (US); Yuka MATSUYAMA, South Pasadena, CA (US)

(73) Assignee: HYPERLOOP TECHNOLOGIES, INC., Los Angeles, CA (US)

(21) Appl. No.: 17/921,872

(22) PCT Filed: Feb. 26, 2021
(86) PCT No.: PCT/US2021/020002

§ 371 Date: Oct. 27, 2022

Related U.S. Application Data
(60) Provisional application No. 63/018,075, filed on Apr. 30, 2020.

(51) Int. Cl. B61B 13/10; B61B 1/02; F16B 5/06

(52) U.S. Cl. CPC B61B 13/10; B61B 1/02; F16B 5/0664

(57) ABSTRACT

A hard capture system for securing a transportation vehicle to an airdock in a high-speed, low-pressure transportation system, wherein the airdock provides a pathway for off-loading and loading of passengers and/or cargo to the transportation vehicle. The hard capture system includes a plurality of latches operable to maintain the transportation vehicle in a fixed position relative to the airdock.

### CROSS-REFERENCE TO RELATED APPLICATION

The present application claims the benefit of U.S. Provisional Application No. 63/018,075, filed Apr. 30, 2020, the contents of which are expressly incorporated herein by reference in their entirety.

### BACKGROUND OF THE DISCLOSURE

### 1. Field of the Disclosure

The present disclosure relates to a hard capture in an airdock assembly, and more specifically relates to a hard capture of a transportation vehicle (or Pod) to an airdock assembly for a high-speed low-pressure transportation system.

### 2. Background of the Disclosure

As the development of high-speed low-pressure transportation systems continue, problems as to how a Pod securely connects with a transportation system station for off-loading passengers and/or cargo need to be solved.

Thus, there is a need for a hard capture system for a Pod in a high-speed low-pressure transportation system.

### SUMMARY OF THE EMBODIMENTS OF THE DISCLOSURE

Aspects of the disclosure are directed to a hard capture system for a Pod in a high-speed, low-pressure transportation system.

By implementing aspects of the disclosure, the Pod and airdock are connected to provide a structural path for the net pressure load of the door opening, and for reacting of sealing loads.

Aspects of the disclosure are directed to a hard capture system for securing a transportation vehicle to an airdock in a high-speed, low-pressure transportation system, wherein the airdock provides a pathway for off-loading and loading of passengers and/or cargo to the transportation vehicle, the hard capture system comprising a plurality of latches operable to maintain the transportation vehicle in a fixed position relative to the airdock.

In embodiments, the transportation vehicle includes a corresponding plurality of catches to respectively receive the plurality of latches.

In further embodiments, the hard capture system additionally comprises one or more sensors operable to detect engagement of the latches with the catches.

In additional embodiments, the hard capture system additionally comprises one or more sensors operable to detect engagement of the catches with the latches.

In yet further embodiments, the one or more sensors are load sensors and/or contact sensors operable to detect the engagement.

In embodiments, each latch is non-back-drivable and/or self-locking.

In some embodiments, each latch is configured to extend and rotate to move into locking engagement with a respective catch.

In further embodiments, each latch is configured to pivot or swing to move into locking engagement with a respective catch.

In additional embodiments, each latch is configured as a 4-bar linkage operable to slide and retract to move into locking engagement with a respective catch.

In yet further embodiments, each latch is configured as a 4-bar linkage operable to circumferentially swing and retract to move into locking engagement with a respective catch.

In some embodiments, each latch includes a track follower operable to move within a track actuator to circumferentially swing and retract the latch to move the latch into locking engagement with a respective catch.

In embodiments, each latch includes a dual jaw operable for locking engagement with a respective catch.

In further embodiments, the hard capture system is operable to ensure sealing between the transportation vehicle and the airdock.

In additional embodiments, the latches are configured to react to a door plug load to hold the transportation vehicle aligned relative to the airdock in at least in a y-direction.

In yet further embodiments, the latches provides a structural path from the transportation vehicle to the airdock for a net pressure load of door opening and for reacting of sealing loads.

In embodiments, the hard capture system additionally comprises at least one seal arranged between the airdock and the transportation vehicle, wherein the latches provide a compression load to the at least one seal.

Additional aspects of the disclosure are directed to a method of operating a hard capture system for securing a transportation vehicle to an airdock in a high-speed, low-pressure transportation system, wherein the airdock provides a pathway for off-loading and loading of passengers and/or cargo to the transportation vehicle, the method comprising engaging a plurality of latches arranged on the airdock with a corresponding plurality of catches arranged on the transportation vehicle to maintain the transportation vehicle in a fixed position relative to the airdock.

In embodiments, the method further comprises using one or more sensors to detect engagement of the latches with the catches.

In further embodiments, when the latches are engaged with the catches, the latches provides a structural path from the transportation vehicle to the airdock, and the method further comprises reacting a net pressure load of door opening via the structural path, and reacting sealing loads via the structural path.

In additional embodiments, the method further comprises providing a compression load to at least one seal arranged between the airdock and the transportation vehicle.

### BRIEF DESCRIPTION OF THE DRAWINGS

The novel features which are characteristic of the systems, both as to structure and method of operation thereof, together with further aims and advantages thereof, will be understood from the following description, considered in connection with the accompanying drawings, in which embodiments of the disclosure are illustrated by way of example. It is to be expressly understood, however, that the drawings are for the purpose of illustration and description only, and they are not intended as a definition of the limits of the disclosure. For a more complete understanding of the disclosure, as well as other aims and further features thereof, reference may be had to the following detailed description of the embodiments of the disclosure in conjunction with the following exemplary and non-limiting drawings wherein:

FIG. 1 shows an exemplary Pod Bay branch layout including an overhead view of an embodiment of two portal branches having eight Pod Bays and a cross-sectional view of the portal branches of the Pod Bay in accordance with aspects of the disclosure;

FIG. 2A shows an exploded perspective view of an exemplary and non-limiting airdock assembly in accordance with aspects of the disclosure;

FIG. 2B shows a perspective view of the exemplary and non-limiting airdock assembly of FIG. 2A in accordance with aspects of the disclosure;

FIGS. 3A-3D show exemplary top views of a process of a Pod engaging with a Pod Bay airdock in accordance with aspects of the disclosure;

FIG. 4 shows an exemplary depiction of the different volumes of the airdock/Pod connection including the portal branch volume, the walkway volume, and the interstitial volume between the airdock door and the Pod door in accordance with aspects of the disclosure;

FIGS. 5A and 5B shown an exemplary hard capture system in accordance with aspects of the disclosure;

FIG. 6A shows a sectional view of exemplary latch assembly in accordance with aspects of the disclosure and FIG. 6B shows exemplary embodiments of a latch control system 650 in accordance with aspects of the disclosure;

FIG. 7 shows another exemplary embodiment of a latch assembly in which the latch engagement utilizes a twist lock (or latch) in accordance with aspects of the disclosure;

FIGS. 8 and 9 show exemplary embodiments of a twist lock latch assembly in accordance with aspects of the disclosure;

FIG. 10 shows an exemplary latching sequence of the twist lock latch assembly in accordance with aspects of the disclosure;

FIG. 11 shows an exemplary layout (location and orientation) of latch assemblies (including respective actuators) on an airdock and engaged with respective catches of a Pod in accordance with aspects of the disclosure;

FIG. 12 shows an exemplary packaging of the twist lock hard capture system in accordance with aspects of the disclosure;

FIG. 13 shows exemplary and non-limiting latch assemblies structured and arranged to swing the latch into the respective catch in accordance with aspects of the disclosure;

FIG. 14 shows an exemplary four-bar linkage (sliding) hard capture latching system in accordance with aspects of the disclosure;

FIGS. 15A-15D show various views of elements of the four-bar linkage (sliding) hard capture latching system in accordance with aspects of the disclosure;

FIG. 16 shows an exemplary layout (location and orientation) of the four-bar linkage (sliding) hard capture latching system (including respective actuators) on an airdock and engaged with respective catches of a Pod in accordance with aspects of the disclosure;

FIG. 17 shows an exemplary top latch assembly in an airdock, with a modified top latch assembly for suitable packaging within the airdock in accordance with aspects of the disclosure;

FIG. 18 shows an exemplary top latch assembly for an exemplary hard capture latching system in accordance with aspects of the disclosure;

FIG. 19 shows another exemplary top latch assembly for an exemplary hard capture latching system in accordance with aspects of the disclosure;

FIGS. 20A and 20B show exemplary four-bar linkage (circumferential swing) hard capture latching systems in accordance with aspects of the disclosure;

FIG. 21 shows an exemplary belt drive hard capture latching system in accordance with aspects of the disclosure;

FIG. 22A shows an exemplary track follower hard capture latching system in an unlatched condition, a latched condition, and various stages therebetween in accordance with aspects of the disclosure;

FIG. 22B shows portions of an exemplary track follower hard capture latching system in accordance with aspects of the disclosure;

FIG. 23 shows an exemplary dual jaw latch hard capture latching system in accordance with aspects of the disclosure;

FIGS. 24A and 24B show an exemplary schematic depiction of a known-length swing latch hard capture system in accordance with aspects of the disclosure;

FIGS. 25A and 25B show schematic views of an exemplary latch hydraulic circuit for reacting the door load once hard capture is achieved and pressure equalization is commenced in accordance with aspects of the disclosure;

FIG. 26 show another exemplary latch hydraulic circuit for reacting the door load once hard capture is achieved and pressure equalization is commenced in accordance with aspects of the disclosure;

FIG. 27 shows an exemplary spring-balanced latch assembly for reacting the door load once hard capture is achieved and pressure equalization is commenced in accordance with aspects of the disclosure;

FIG. 28 shows an exemplary and non-limiting catch assembly on a Pod in accordance with aspects of the disclosure;

FIG. 29 shows exemplary side and section views of latch packaging considerations in accordance with aspects of the disclosure;

FIG. 30 shows an exemplary packaging of a four-bar linkage hard capture system (e.g., a bell crank hard capture system) in accordance with aspects of the disclosure;

FIGS. 31A and 31B show an exemplary schematically-depicted packaging of a swing-of-known-length hard capture system at a cross section of the top latch location (as shown in FIG. 31B) in accordance with aspects of the disclosure;

FIG. 32 shows another exemplary schematically-depicted packaging of a swing-of-known-length hard capture system at a cross section of the top latch location in accordance with aspects of the disclosure;

FIG. 33 shows an exemplary seal in accordance with aspects of the disclosure;

FIG. 34 schematically depicts a Pod with the different types of misalignment due to the loads on a Pod and variance accommodation in accordance with aspects of the disclosure;

FIGS. 35A and 35B show exemplary schematic depictions of airdock door constraints to provide a rotational Z degree of freedom to accommodate for (or prevent) uneven gapping between the airdock and the Pod in accordance with aspects of the disclosure; and

FIG. 36 shows an exemplary environment for practicing aspects of the present disclosure.

### DETAILED DESCRIPTION OF THE EMBODIMENTS OF THE DISCLOSURE

The following detailed description illustrates by way of example, not by way of limitation, the principles of the disclosure. This description will clearly enable one skilled in the art to make and use the disclosure, and describes several embodiments, adaptations, variations, alternatives and uses of the disclosure, including what is presently believed to be the best mode of carrying out the disclosure. It should be understood that at least some of the drawings are diagrammatic and schematic representations of exemplary embodiments of the disclosure, and are not limiting of the present disclosure nor are they necessarily drawn to scale.

The novel features which are characteristic of the disclosure, both as to structure and method of operation thereof, together with further aims and advantages thereof, will be understood from the following description, considered in connection with the accompanying drawings, in which an embodiment of the disclosure is illustrated by way of example. It is to be expressly understood, however, that the drawings are for the purpose of illustration and description only, and they are not intended as a definition of the limits of the disclosure.

In the following description, the various embodiments of the present disclosure will be described with respect to the enclosed drawings. As required, detailed embodiments of the present disclosure are discussed herein; however, it is to be understood that the disclosed embodiments are merely exemplary of the embodiments of the disclosure that may be embodied in various and alternative forms. The figures are not necessarily to scale and some features may be exaggerated or minimized to show details of particular components. Therefore, specific structural and functional details disclosed herein are not to be interpreted as limiting, but merely as a representative basis for teaching one skilled in the art to variously employ the present disclosure.

The particulars shown herein are by way of example and for purposes of illustrative discussion of the embodiments of the present disclosure only and are presented in the cause of providing what is believed to be the most useful and readily understood description of the principles and conceptual aspects of the present disclosure. In this regard, no attempt is made to show structural details of the present disclosure in more detail than is necessary for the fundamental understanding of the present disclosure, such that the description, taken with the drawings, making apparent to those skilled in the art how the forms of the present disclosure may be embodied in practice.

As used herein, the singular forms “a,” “an,” and “the” include the plural reference unless the context clearly dictates otherwise. For example, reference to “a magnetic material” would also mean that mixtures of one or more magnetic materials can be present unless specifically excluded. As used herein, the indefinite article “a” indicates one as well as more than one and does not necessarily limit its referent noun to the singular.

Except where otherwise indicated, all numbers expressing quantities used in the specification and claims are to be understood as being modified in all examples by the term “about.” Accordingly, unless indicated to the contrary, the numerical parameters set forth in the specification and claims are approximations that may vary depending upon the desired properties sought to be obtained by embodiments of the present disclosure. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range (unless otherwise explicitly indicated). For example, if a range is from about 1 to about 50, it is deemed to include, for example, 1, 7, 34, 46.1, 23.7, or any other value or range within the range.

As used herein, the terms “about” and “approximately” indicate that the amount or value in question may be the specific value designated or some other value in its neighborhood. Generally, the terms “about” and “approximately” denoting a certain value is intended to denote a range within ±5% of the value. As one example, the phrase “about 100” denotes a range of 100±5, i.e. the range from 95 to 105. Generally, when the terms “about” and “approximately” are used, it can be expected that similar results or effects according to the disclosure can be obtained within a range of ±5% of the indicated value.

As used herein, the term “and/or” indicates that either all or only one of the elements of said group may be present. For example, “A and/or B” shall mean “only A, or only B, or both A and B”. In the case of “only A”, the term also covers the possibility that B is absent, i.e. “only A, but not B”.

The term “substantially parallel” refers to deviating less than 20° from parallel alignment and the term “substantially perpendicular” refers to deviating less than 20° from perpendicular alignment. The term “parallel” refers to deviating less than 5° from mathematically exact parallel alignment. Similarly “perpendicular” refers to deviating less than 5° from mathematically exact perpendicular alignment.

The term “at least partially” is intended to denote that the following property is fulfilled to a certain extent or completely.

The terms “substantially” and “essentially” are used to denote that the following feature, property or parameter is either completely (entirely) realized or satisfied or to a major degree that does not adversely affect the intended result.

The term “comprising” as used herein is intended to be non-exclusive and open-ended. Thus, for example a composition comprising a compound A may include other compounds besides A. However, the term “comprising” also covers the more restrictive meanings of “consisting essentially of” and “consisting of”, so that for example “a composition comprising a compound A” may also (essentially) consist of the compound A.

The various embodiments disclosed herein can be used separately and in various combinations unless specifically stated to the contrary.

Embodiments of the present disclosure may be used in a low-pressure high-speed transportation system, for example, as described in commonly-assigned U.S. Pat. No. 9,718,630, titled “Transportation System,” the contents of which are hereby expressly incorporated by reference herein in their entirety. For example, the segmental tube structure may be used as a transportation path for a low-pressure, high-speed transportation system. In embodiments, a low-pressure environment within a sealed tubular structure may be approximately 100 Pa. Additionally, embodiments of the present disclosure may be used with airdock assembly methods and systems, for example, as described in commonly-assigned Patent Application No. ______ (Attorney Docket No. P62099), titled “Airdock Assembly,” soft capture methods and systems, for example, as described in commonly-assigned Patent Application No. ______ (Attorney Docket No. P62100), titled “Airdock Soft Capture,” and Pod Bay and docking systems and methods, for example, as described in commonly-assigned International Patent Application No. ______ (Attorney Docket No. P62102), titled “Pod Bay and Vehicle Docking,” filed on even date herewith, the contents of each of which are hereby expressly incorporated by reference herein in their entireties.

In accordance with aspects of the disclosure, the Pod Bay is a station where passengers and/or cargo, and resources are transferred to the Pod (or transportation vehicle). More specifically, the Pod Bay is where passengers embark onto/disembark from the Pod while, in accordance with aspects of the disclosure, the Pod remains in a vacuum (or near vacuum) environment. With an exemplary and non-limiting embodiment, each Pod Bay has two airdocks. An airdock is where each of the Pod doors is aligned to transfer passengers and cargo to and from the Pod. In accordance with aspects of the disclosure, airdock mechanisms align the Pod doors to respective airdocks. A Resource Transfer System (RTS) RTS is used to replenish a Pod with resources (such as battery charge and breathable air, for example) while the Pod is docked in the Pod Bay. A soft capture system is used once the Pod is parked. The soft capture system is used to close the gap between the Pod doors and respective airdock doors and align the two with each other. In embodiments, the alignment process may utilize two steps: rough alignment and final alignment.

A hard capture system is utilized once final alignment of the Pod and airdock doors is achieved. With an exemplary embodiment, the hard capture system maintains the Pod in fixed position relative to the airdock with a series of latches.

Once the Pod arrives at the assigned Pod Bay, the soft capture system moves the Pod towards the airdocks so that the Pod and mating airdocks are properly aligned. With an exemplary embodiment, the soft capture process will move the Pod in the Y-direction (or approximate Y-direction) by approximately 250 mm. Once alignment is confirmed, the hard capture latches engage with the respective catches on the Pod. The hard capture process ensures sealing between the Pod and airdock. Once pressures of different volumes (e.g., airdock volume, interstitial volume, Pod cabin volume) are equalized within an acceptable range, the doors open to transfer passengers. For take-off, the general sequence is the reverse of the steps described above.

As described further below, the Pod Bay is a building block of a portal branch system, wherein each portal may have multiple portal branches, and there may be multiple Pod Bays within a portal branch to meet the required throughput demand. One or more airdocks are arranged in the Pod Bay, wherein each airdock is a structure that connects the Pod door to Pod Bay door of the Pod Bay.

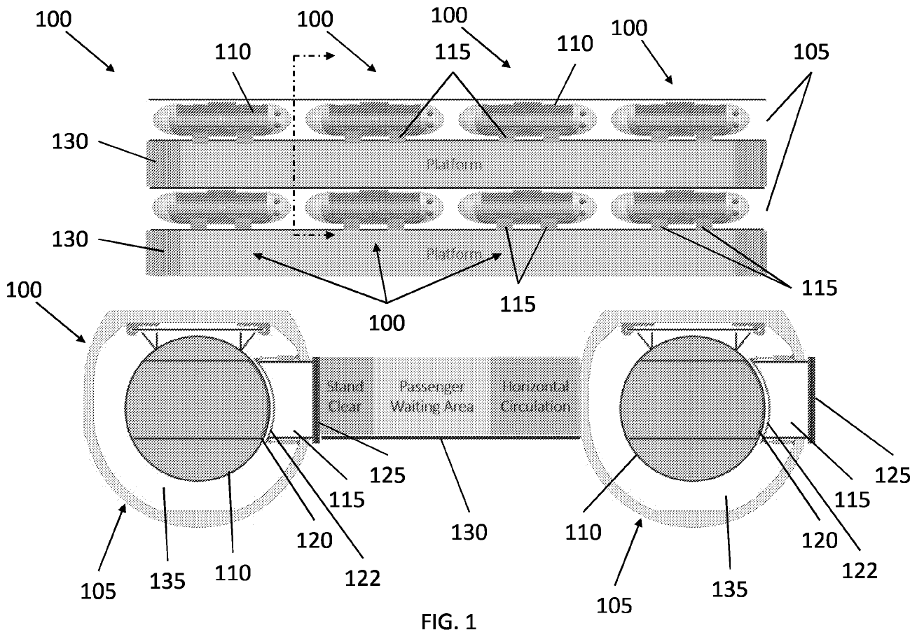

FIG. 1 shows an exemplary Pod Bay branch layout including an overhead view of an embodiment of two portal branches 105 having eight Pod Bays 100 and a cross-sectional view of the portal branches of the Pod Bay in accordance with aspects of the disclosure. As shown in FIG. 1, a plurality of pods 110 may be parked at respective airdocks 115 (or pairs of airdocks 115) arranged in the Pod Bay 100, wherein each airdock 115 is a structure that connects the Pod door 120 to bulkhead door 125 of the Pod Bay 100. While not shown in FIG. 1, in embodiments the airdock 115 may also include an airdock door adjacent the Pod door.

Each branch 105 of the Pod Bay 100 may include a platform 130 for passenger movement, including areas for passengers waiting, horizontal circulation regions, and a “stand clear” area. As shown in FIG. 1, in accordance with aspects of the disclosure, the Pod 110 remains in a vacuum (or near vacuum) environment 135, while passengers embark onto and/or disembark from the Pod 120 via the airdock 115. The environment of the airdock cycles between the vacuum (or near vacuum) environment of the transportation tube, and an ambient pressure environment of the platform 130 to allow passengers to embark onto and/or disembark from the Pod 110 via the airdock 115.

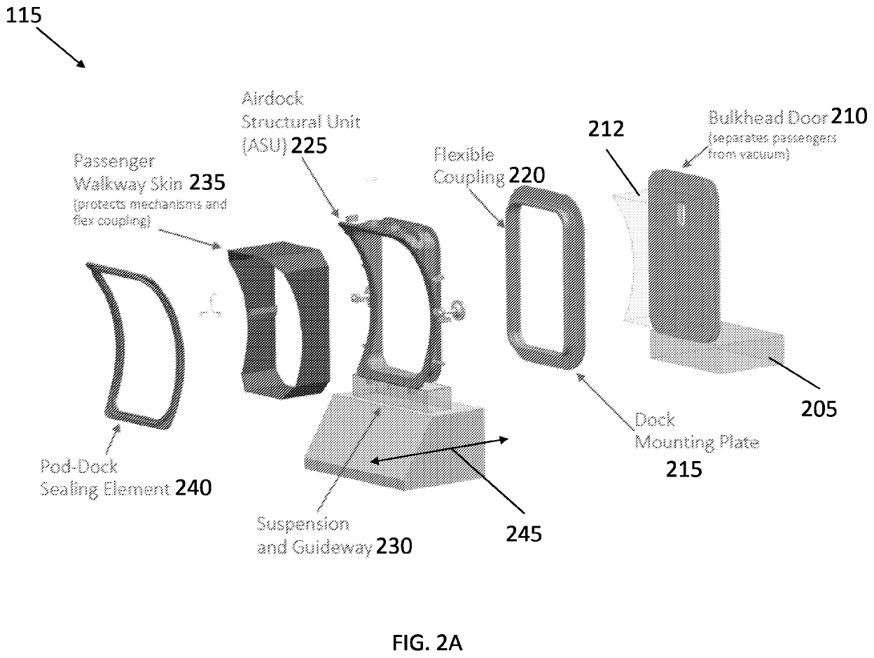

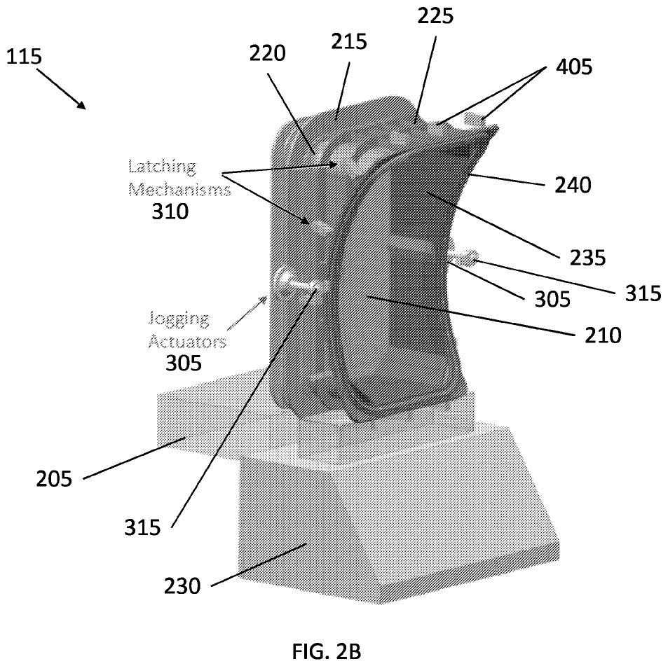

FIG. 2A shows an exploded perspective view of an exemplary and non-limiting airdock assembly 115 (or airdock) in accordance with aspects of the disclosure. As shown in FIG. 2A, the airdock assembly 115 includes a walkway 205, which connects to the Pod Bay station platform (not shown). A moveable bulkhead door 210 is arranged on the walkway 205, and when in the closed position, separates waiting passengers in the station from the vacuum or near vacuum (e.g., low pressure) environment of the Pod transportation path. When the bulkhead door 210 is in the open position (not shown), a pathway is provided from the station platform to the interior of the airdock assembly 115. As shown in FIG. 2A, with this exemplary embodiment, the bulkhead door 210 includes an air plunger 212 attached to the interior side thereof. The airdock assembly 115 also includes a dock mounting plate 215 arranged in contact with the frame of the bulkhead door 210 and a flexible coupling 220 arranged on the dock mounting plate 215.

As additionally shown in FIG. 2A, a suspension and guideway 230 is provided upon which an airdock structural unit (ASU) 225 is arranged. While not shown in FIG. 2A, the flexible coupling 220 is in sealing contact with the ASU 225. In accordance with the aspects of the disclosure, in some exemplary embodiments, the suspension and guideway 230 is operable to move away from (and towards) the walkway 205 and bulkhead door 210 (in direction of arrow 245) so as to move the ASU 225 towards (and away) a Pod to make connection with a Pod (not shown) arranged in the Pod Bay (not shown). As the ASU 225 is moved towards a Pod, the flexible coupling 220 is configured to flex (and, for example, extend or stretch) so as to maintain a seal between the dock mounting plate 215 and the ASU 225. In contemplated embodiments, the flexible coupling 220 may be expandable towards the Pod by a distance of approximately 50 mm. In some contemplated embodiments, the flexible coupling 220, in addition to allowing for horizontal movement, can also allow for vertical movement of the ASU 225 relative to the dock mounting plate 215. The flexible coupling 220 may comprise rubber, with other elastomeric materials contemplated by the disclosure.

A passenger walkway skin 235 is arranged within the airdock structural unit 225. In embodiments, the passenger walkway skin 235 may be metal or plastic. In accordance with aspects of the disclosure, the passenger walkway skin 235, in addition to maintaining the required pressure in the airdock 115, protects mechanisms and the flexible coupling 220. A Pod-dock sealing element 240 is arranged on an end of the ASU 225 and is structured to provide sealing engagement with a Pod (not shown). In embodiments, the sealing element 240 may be an inflatable bulb seal or may be a solid seal. The Pod-dock sealing element 240 minimizes leakage through any gaps between the ASU 225 and the Pod (not shown).

As shown in FIG. 2A, the platform-side of the airdock assembly 115 has a planar or flat surface, whereas the vehicle side of the airdock assembly 115 has a curved surface so as to match (or approximately match) the external curved profile of the transportation vehicle (i.e., the Pod).

FIG. 2B shows a perspective view of the exemplary and non-limiting airdock assembly 115 of FIG. 2A in accordance with aspects of the disclosure. As shown in FIG. 2B, the airdock assembly 115 includes a walkway 205, which connects to the Pod Bay station platform (not shown). A moveable bulkhead door 210 (shown in the closed position) is arranged on the walkway 205, and when in the closed position (as shown), separates waiting passengers in the station from the vacuum or near vacuum (e.g., low pressure) environment of the Pod transportation path. When the bulkhead door 210 is in the open position (not shown), a pathway is provided from the station platform to the interior of the airdock assembly 115. The airdock assembly 115 also includes a dock mounting plate 215 arranged in contact with the frame of the bulkhead door 210 and a flexible coupling 220 arranged on the dock mounting plate 215.

As additionally shown in FIG. 2B, the suspension and guideway 230 is provided, upon which the airdock structural unit (ASU) 225 is arranged. As shown in FIG. 2B, the flexible coupling 220 is in sealing contact with the ASU 225. As discussed above, in some embodiments the suspension and guideway 230 is operable to move away from (and towards) the walkway 205 and bulkhead door 210 so as to move the ASU 225 towards (and away) a Pod to make connection with a Pod (not shown) arranged in the Pod Bay (not shown). As the ASU 225 is moved towards a Pod, the flexible coupling 220 is configured to flex (and, for example, extend or stretch) so as to maintain a seal between the dock mounting plate 215 and the ASU 225.

As shown in FIG. 2B, the passenger walkway skin 235 is arranged within the airdock structural unit 225. The Pod-dock sealing element 240 is arranged on an end of the ASU 225 and is structured to provide sealing engagement with a Pod (not shown). FIG. 2B also shows jogging actuators 305 arranged on each side of airdock 115, with ends thereof connected between the dock mounting plate 215 and the Pod-side end of the ASU 225. In contemplated embodiments, the ends of the jogging actuators 305 which connect to the ASU 225 (e.g., the Pod-side end of the ASU 225) include ball joints so that the ASU 225 can be tilted or skewed (e.g., slightly), if necessary, when attaching to the Pod (not shown). In accordance with aspects of the disclosure, the jogging actuators 305 are utilized (in conjunction with additional elements) to attain a soft capture of the Pod.

As further shown in FIG. 2B, the airdock assembly 115 also includes latching mechanisms 310 (schematically depicted) arranged on the periphery of the ASU 225 (e.g., ten latching mechanisms 310). In accordance with aspects of the disclosure, the latching mechanisms 310 are configured to attach (e.g., latch) to the Pod so secure the Pod to the airdock assembly 115. More specifically, the latching mechanisms 310 are utilized (in conjunction with additional elements) to attain a hard capture of the Pod, in accordance with aspects of the disclosure. While the latches are depicted on the external side of the airdock assembly, the present disclosure contemplates that the latches could be inboard of the seal, which may (slightly) reduce the volume of air plunged out. Additionally, while these exemplary latches are described in the context of a move-the-airdock architecture, the disclosure contemplates these latches may also be utilized with a move-the-Pod architecture.

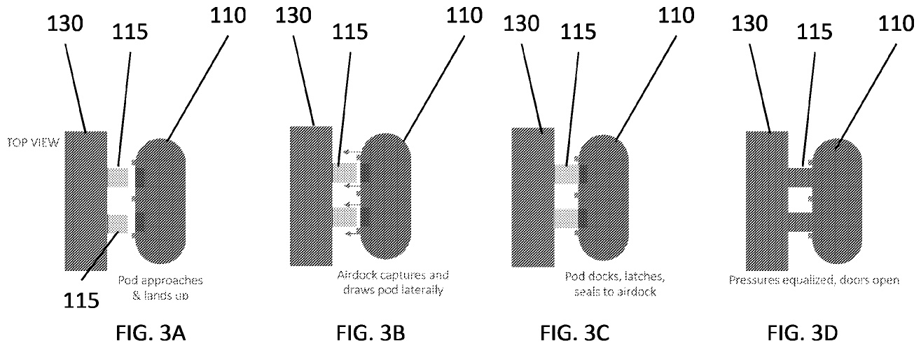

FIGS. 3A-3D show exemplary top views of a process of a Pod 110 engaging with a Pod Bay airdock 115 in accordance with aspects of the disclosure. As shown in FIG. 3A, the Pod 110 approaches the airdock 115 of the Pod Bay and, in embodiments, the Pod 110 lands upwardly onto the transportation tracks, or in other embodiments, the Pod 110 hovers (or levitates) below the transportation tracks. As shown in FIG. 3B, a soft capture of the Pod 110 occurs, wherein the airdock 115 captures and draws the Pod 110 laterally, for example, toward the airdock 115 (as represented by the arrows). As shown in FIG. 3C, a hard capture of the Pod 110 occurs, wherein the airdock 115 latches to the Pod 110 and seals the airdock 115 to the Pod 110. As shown in FIG. 3D, once hard capture is achieved, the airdock 115 is flooded so that pressures are equalized between the pressure of the interior of the Pod 110 (and the pressure of the platform 130) and the pressure of the airdock 115. In other words, the pressure in the airdock 115 is raised to the pressure of the interior of the Pod 110 (and the pressure of the platform 130). Once pressure is equalized, the doors of the Pod and of the Pod Bay open to permit embarking (and dis-embarking) of passengers.

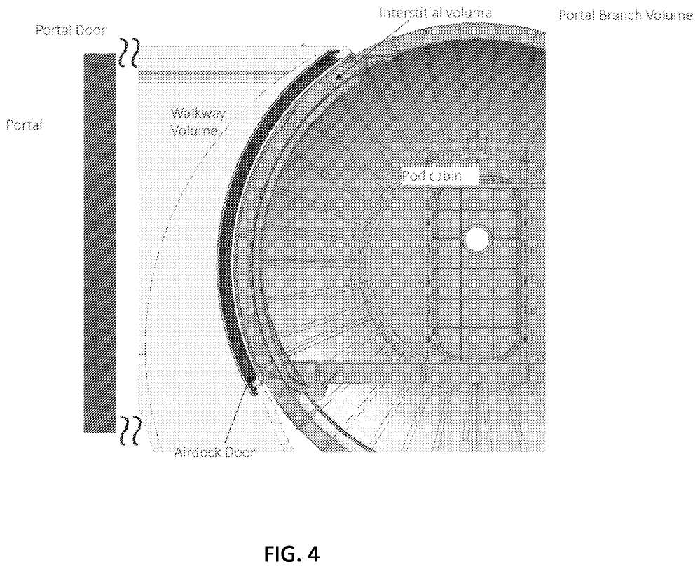

FIG. 4 shows an exemplary depiction of the different volumes of the airdock/Pod connection including the portal branch volume, the walkway volume, and the interstitial volume between the airdock door and the Pod door. In accordance with aspects of the disclose, the interstitial volume between the Pod fuselage and airdock door is pressurized/depressurized during each cycle, and the pressure in the airdock walkway that connects the Pod to the portal needs to be maintained within a certain range to ensure passenger safety. A high-level sequence of actions/events of an exemplary Pod docking process may include:

0. Latch engagement sequence completed confirmed;

1. Pressurize interstitial volume by opening valve(s) to portal (Pod may begin pressure equalization process at this time);

2. Confirm interstitial volume is within the specified range;

3. [Event: airdock door opens];

4. (Pod confirms cabin pressure is equalized);

5. [Event: Pod and portal doors open];

6. [Event: Pod, airdock and portal doors close];

7. Depressurize interstitial volume by opening valve(s) to tube;

8. Confirm interstitial volume is below X Pa.;

9. Begin latch disengagement sequence; and

10. Pressurize bulb seal with compressed air.

Redundant pressure sensors within the airdock walkway may be provided, and used to monitor the pressure as well as to confirm the pressure is within the same range to open or close the doors. Prior to opening the door(s), both Pod and Pod Bay need to confirm that it is safe to open the door(s). In an exemplary embodiment, de/pressurization of the interstitial volume may be accomplished by passively moving the air at 1 atm.

In order to transfer passengers, the Pod will be assigned to a Pod Bay through command and control. In embodiments, a Pod may have two doors, and the two doors on the Pod and the two doors at the Pod Bay will be aligned properly prior to passenger transfer. Once all conditions are met, the doors of the Pod and the doors of the Pod Bay open for passenger dis/embarkation.

The primary function of the Pod Bay is to safely transfer passengers from the Pod/portal to portal/Pod. Depending upon the architecture selected, in embodiments, the Pod Bay operation includes following: Pod parking itself within an assigned Pod Bay, soft capture, Pod landing onto (or hovering below) levitation track, hard capture, pressure equalization. As noted above, the Pod docking process may utilize two steps: soft capture and hard capture. Soft capture includes bringing the Pod towards the airdock and aligning the Pod to airdock and/or the airdock to Pod. Hard capture utilizes latches, which react the door plug load to hold the Pod in the aligned Y position. Additionally, in some embodiments the latches may be used to compress seals between the Pod and airdock. In alternative embodiments, the seal may be inflated after latches are engaged so that the latches are not used to compress the seal. Thus, the functions of the hard capture system are to react to the door plug load (e.g., load on latch 6 kN-261N depending on location), accommodate variations in relative latch-to-catch position due to manufacturing, thermal, and/or pressure effects, and compress the seal (e.g., approximately 6 mm). Additionally, in embodiments, the latch may need to be able to draw back approximately 6 mm from where it contacts the Pod catch (in embodiments, this may also be accomplished by soft capture).

Depending upon the architecture selected, once the Pod arrives at the assigned Pod Bay, the soft capture system moves the Pod towards the airdocks so that the Pod and mating airdocks are properly aligned. Once alignment is confirmed, the hard capture latches engage with the respective catches on the Pod so that the sealing between the Pod and airdock can be ensured. Once pressures of different volumes (Airdock volume, interstitial volume, Pod cabin volume) are equalized within an acceptable range, the doors open to transfer passengers. For take-off, the general sequence is the reverse of the steps described above.

Pod parking commences with the command and control communicating to the Pod the assigned Pod Bay location. Command and control is responsible for ensuring proper and safe movement of pods, receiving status and/or data, making safety and mission critical decisions, and issuing commands to Pod and Operation Support System (OSS) to be carried out. OSS is responsible for the operational management of Portal and Depot, the central command of active wayside elements and providing communication network to support System operations.

Then, depending upon the architecture selected, the Pod parks itself relative to the reference monument in the Pod Bay within a certain range. This reference is only in the direction of travel (X). The Pod levitation and guidance engines are already capable of maintaining the Pod position within a tight lateral (Y) and vertical (Z) envelope. A separate monument in the X direction may be necessary as the track system used for normal transportation may not maintain information on the Pod's global position. In embodiments, this monument should be sensed and measured by the Pod to enable braking, positioning and landing within the capture envelope. With the Pod's landing accuracy of +/−50 mm currently assumed along with manufacturing tolerances, the capture envelope should be able to accommodate +/−72 mm in the X direction.

Once the Pod is parked within the Pod Bay, the soft capture system brings the Pod towards the airdock doors by either pulling or pushing the Pod in the Y direction (or approximate Y-direction), and then aligning the Pod doors to the airdock doors. The soft capture system should be able to accommodate variations in relative positioning of the Pod doors and airdock doors due to manufacturing variation, thermal and pressure effect as well as the Pod's parking accuracy.

In contemplated embodiments, the soft capture system may include the following subassemblies: soft capture mechanisms, final kinematic alignment features, compliant element between the airdock door and portal, and airdock mass offloading system. The soft capture mechanism, which in embodiments, may be a set of tension cables, or actuator, moves the Pod towards the airdock doors. The final alignment elements on the Pod and Pod Bay are intended to ensure the respective doors at both locations are properly aligned during the soft capture process. The airdock doors may be housed within the airdock structure, which is connected to the portal branch by a flex joint. The airdock structure should be supported such that the airdock doors can be aligned to the respective Pod doors while accommodating expected variations described above, and flex joint is intended to allow such adjustability.

Once soft capture completion is detected, in embodiments, the Pod will land up against the solid levitation/landing track (wherein airdocks may be pulled by ˜15 mm as the Pod pulls up). (With other contemplated embodiments, the Pod may remaining hovering. And with yet further contemplated embodiments, the Pod may land first before soft capture.) In accordance with aspects of the disclosure, once soft capture is attained, the hard capture process commences. Upon landing, the Pod can either communicate directly to the Pod Bay that it is in a ready state for hard capture, or the Pod Bay can sense that the Pod is properly positioned and ready for hard capture. In contemplated embodiments, this could be accomplished by sensing that the levitation gap is closed with a proximity sensor and/or measuring the position of some Pod side reference target to confirm that the Pod is within the capture envelope.

Hard capture is the process of connecting the airdock and the Pod to provide a structural path for the net pressure load of the door opening, and for reacting of sealing loads. The hard capture system comprises an array of latches and seals that close the gap between the Pod fuselage and airdock structure. In accordance with aspects of the disclosure, when engaged, the latches provide the primary load path to react the door plug load when the pressure differential across the Pod door and the airdock door opening is removed.

The latches also provide the load to keep the seals compressed. In embodiments, the soft capture system may also to be sized to act as a secondary load path in case of significant latch array failure. As described herein, once all the latches are confirmed to be engaged, the pressure equalization process is initiated.

The latching positions align with the Pod door stops on the Pod door frame so that, in accordance with aspects of the disclosure, the door plug load is transferred to the Pod Bay/airdock through the same locations when the pressure differential across the Pod door and the airdock door opening is removed. With an exemplary and non-limiting embodiment, the latch/door stop positions are arranged at the intercostals of the Pod fuselage, with sixteen latches per door, eight on each side.

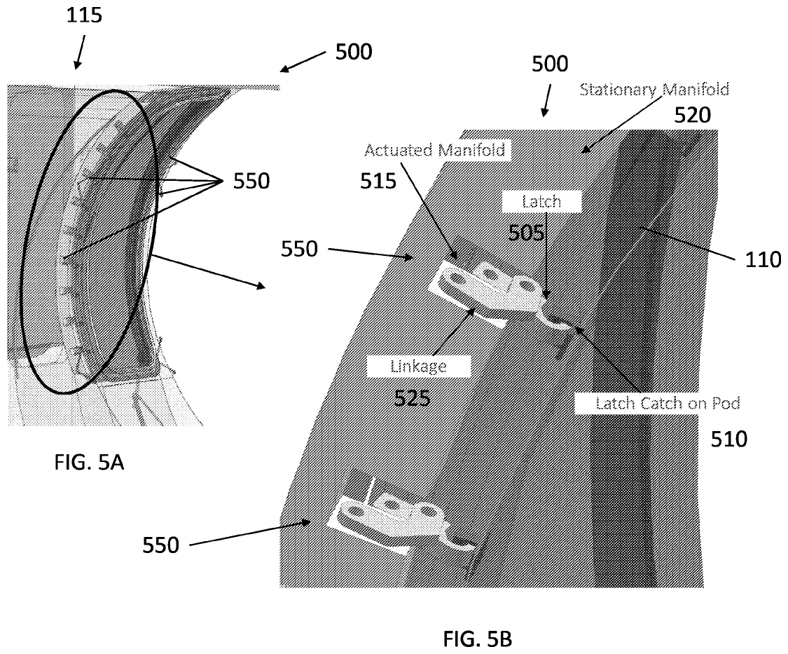

FIGS. 5A and 5B shown an exemplary hard capture system 500 in accordance with aspects of the disclosure. FIG. 5A shows the hard capture system 500 on the airdock 115 having a plurality of latch assemblies 550 and FIG. 5B shows a closer view of an exemplary latch assembly 550 of the hard capture system 500. As shown in FIGS. 5A and 5B, the hard capture system 500 includes a set of latch assemblies 550 comprising latches 505 (for example, sixteen) per door. The latches 505 are structured to react the door plug load and to apply a Pod-airdock seal compression load. With the exemplary and non-limiting latch assembly 550, as shown in FIG. 5B, the latch 505 is structured to pivot from the stationary manifold 520 via the linkage 525 and the actuated manifold 515 so as to selectively engage the respective catch 510 arranged on the Pod 110.

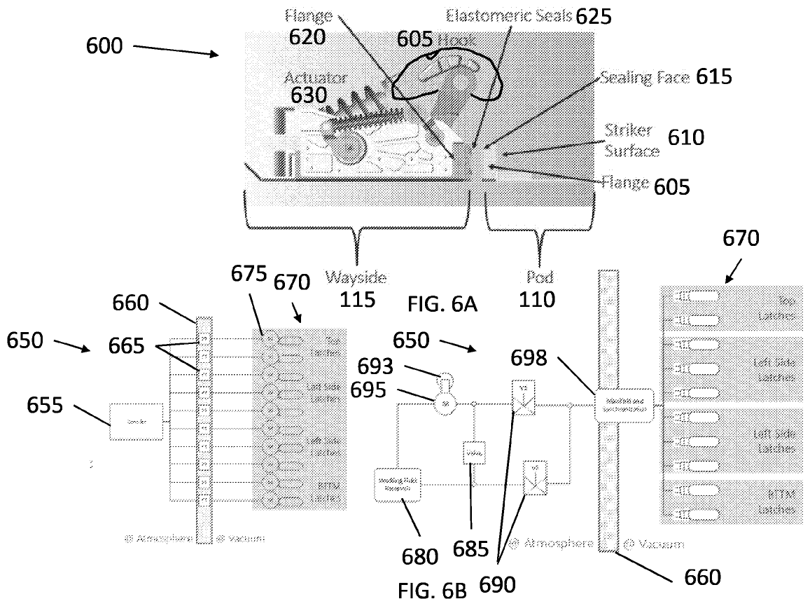

FIG. 6A shows a sectional view of an exemplary latch assembly 600 in accordance with aspects of the disclosure. As shown in FIG. 6A, the latch assembly 600 on the airdock 115 (wayside) includes an actuator 630 that is operable to move the latch (or hook) 605 into engagement with the catch 510 on the Pod 110. The catch 510 may include a flange 605 having a striker (or engagement) surface 610 and a sealing face 615 on the other side of the flange 605. The latch assembly 550 includes a flange 620 having elastomeric seals 625, which engage with the sealing face 615 of the latch 505 (when the latch 505 is engaged).

FIG. 6B shows exemplary embodiments of a latch control system 650 in accordance with aspects of the disclosure. As shown in FIG. 6B, the latch control system 650 may include a controller 655 at atmospheric pressure in communication through a pressure barrier 660 with a plurality of the latches 670 (e.g., topside latches, right-side latches, left-side latches, and/or bottom latches, which are at vacuum pressure. Each communication line may include a pressure transducer (PT) 660 and a motor 675. Additionally, as shown in the right side of FIG. 6B, the latch control system 650 may also include a motor 695 driving a fluid pump 693, a fluid reservoir 680, a plurality of valves 685, 690, and a manifold and synchronization control 698.

With another exemplary embodiment, there may be eighteen latches per door, and three kinematic mounts that define position of the airdock relative to the Pod. The latches may be placed evenly-spaced around the door and oriented radially. All latches should be able to sense engagement via either load or contact. The latches also should provide a surface for the Pod to sense that they are engaged. With an exemplary and non-limiting embodiment, the latches may be non-backdrivable self-locking electromechanical actuators. The latches are not required to draw in the vehicle or bring systems into contact; rather the latches are simply actuated until engaged with their catches, and then hold position until the release sequence is commanded.

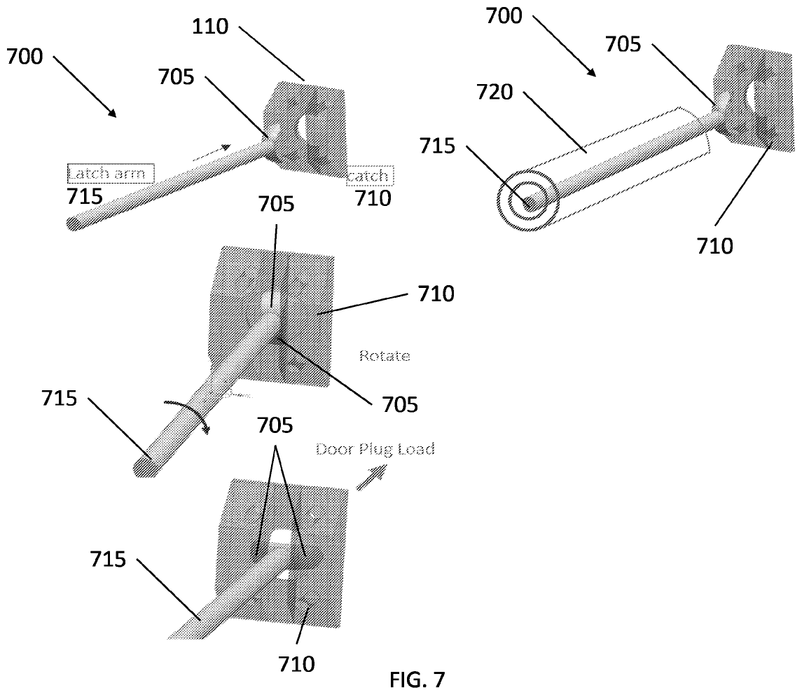

FIG. 7 shows another exemplary embodiment of a latch assembly 700 in which the latch engagement utilizes a twist lock (or latch) 705 in accordance with aspects of the disclosure. As shown in FIG. 7, the latch 705 is operable to extend into the catch 710 on the Pod 110, rotate, for example, ninety degrees, and then retract until contact between the latch 705 and catch 710 is detected. Ideally the Pod and Pod Bay/airdocks are properly aligned by the soft capture system so that the hard capture system does not require alignment capability. In such a manner, in accordance with aspects of the disclosure, wear and tear in the array of latches 705 should be small and only due to the contact load. With this exemplary embodiment, circumferential variation may be accommodated by flexing the latch arm and/or the catch could be floated circumferentially and axial variation may be accommodated by flexing the latch arm. In embodiments, the latch arm is sized with a sufficient length so that the Pod does not need to apply any deflection load.

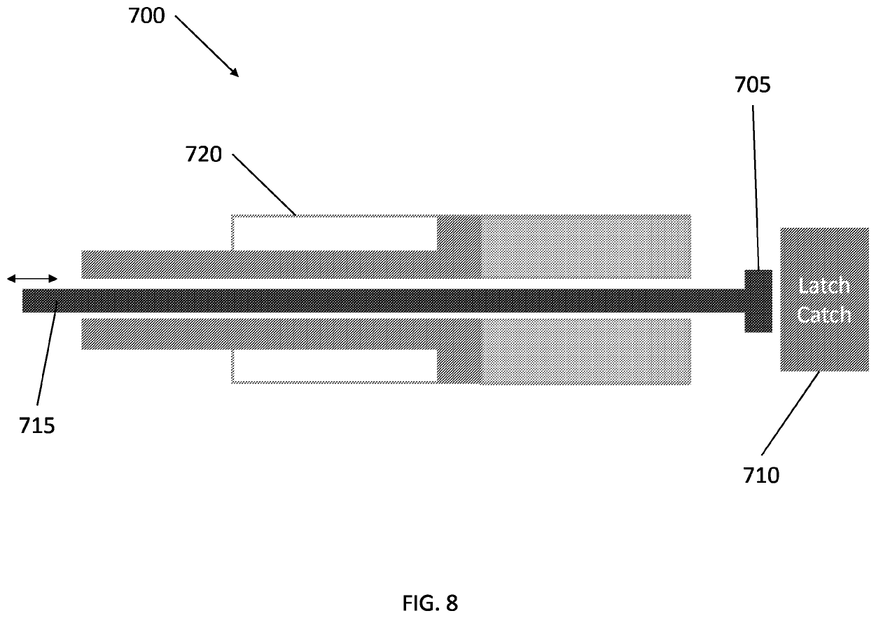

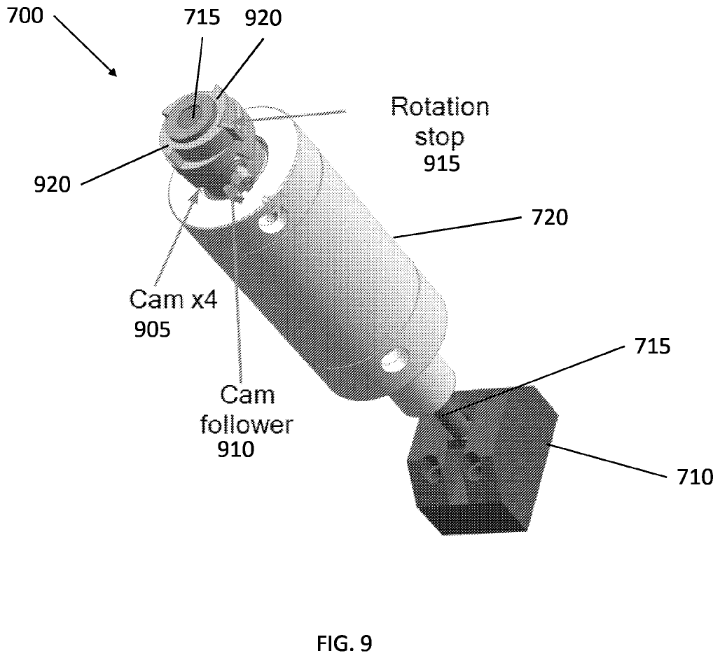

FIGS. 8 and 9 show exemplary embodiments of a twist lock latch assembly in accordance with aspects of the disclosure. As shown in FIGS. 8 and 9, in embodiments, the set of motions of the twist lock latch assembly 700 may be achieved using a double acting hydraulic cylinder 720 with a passive rotation feature e.g., an actuator that can actively axially move the latch and also rotate the latch; or actively move axially and passively rotate with the cause of a cam system) to minimize moving parts. In embodiments, the actuator may utilize a hole through the rod (either the axial actuator can rotate as a whole, or the rotation mechanism/actuator can axially float or accommodate axial motion of the rod. As shown in FIG. 9, the passive rotation feature may include, for example, a set of four mating angled teeth 920 and a rotation stop 915. As the latch arm 715 (or latch arm) extends, the cam 905 and cam follower 910 engage and rotate the actuator rod 715. After making a full ninety-degree rotation, the rotation stop 915 engages the angled tooth 920, preventing the rod 715 from rotating backwards as the latch arm retracts.

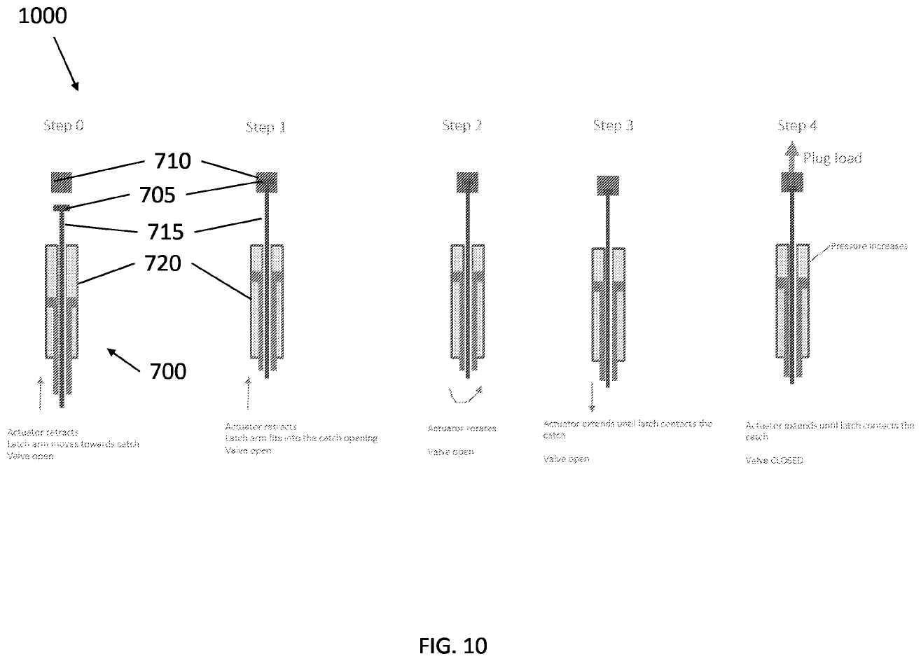

FIG. 10 shows an exemplary latching sequence 1000 of the twist lock latch assembly 700 in accordance with aspects of the disclosure. As shown in FIG. 10, at step 0, the actuator 715 retracts (or extends) in the direction shown, the latch arm 705 moves toward the catch 710, and the valve of cylinder 720 is open. As shown in FIG. 10, at step 1, the actuator 715 continues to retract (or extend) in the direction shown, the latch arm 705 fits into the catch 710 opening, and the valve of the cylinder 720 is open. As shown in FIG. 10, at step 2, the actuator 715 rotates, the latch arm 705 fits into the opening of the catch 710, and the valve of cylinder 720 is open. As shown in FIG. 10, at step 3, the actuator 715 extends (or retracts) in the direction shown until the latch 705 contacts and engages with the catch 710 and the valve of cylinder 720 is open. As shown in FIG. 10, at step 4, the valve of cylinder 720 is closed so that the cylinder 720 can react to the plug load. As shown in FIG. 10, when the plug load is applied between the latch arm 705 and the catch 710, the pressure in the closed cylinder 720 is operable to react to the plug load in accordance with aspects of the disclosure.

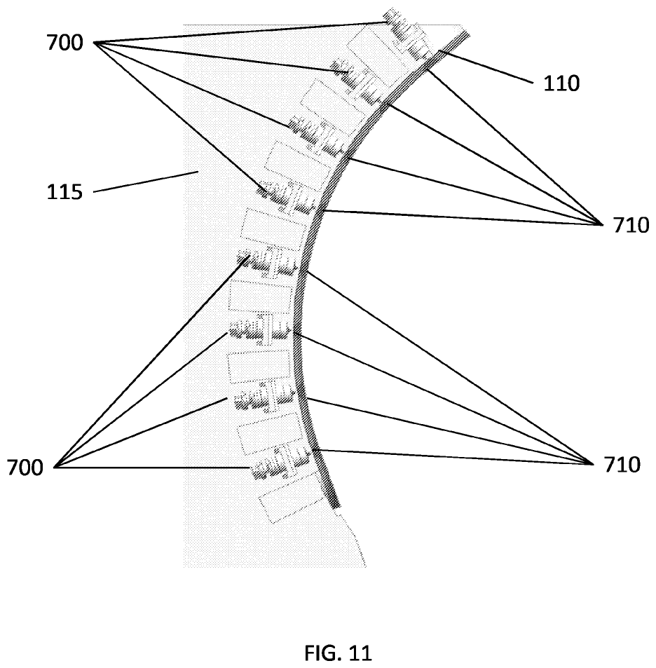

FIG. 11 shows an exemplary layout (location and orientation) of latch assemblies 700 (including respective actuators) on an airdock 115 and engaged with respective catches 710 of a Pod 110 in accordance with aspects of the disclosure. With an exemplary embodiment, all of the latches around the door (or in an alternative embodiment, latches on one side of the door) may be on a common hydraulic circuit, and opening and closing the valve to the circuit actuates the latches.

Latches at the top and the bottom of the door along the periphery are expected to carry more plug load than the ones in the middle of the door. In accordance with aspects of the disclosure, placing a pilot operated (PO) check valve in each latch hydraulic line allows the pressure to increase independently in each line; as noted above, the top and bottom latch actuator pressure is expected to be higher than those in the middle. In accordance with additional aspects of the disclosure, one way to confirm latch engagement is to build up low pressure in the hydraulic cylinder prior to starting pressure equalization process. The hydraulic cylinder pressure increase can also be monitored while the interstitial volume pressure is increased to ensure that each latch is carrying the expected load. Hall Effect or laser sensors may be used, for example, to confirm proper latch engagement as well.

The hard capture latching mechanism may utilize a set of hydraulic actuators and sensors. In an exemplary embodiment, actuators on one side or both sides of the airdock are on one hydraulic circuit and operated by opening and closing the valve for the circuit. Once the latch engagement is confirmed, the valve for the circuit closes to hold the actuator positions as latches engaged. Each actuator line is installed with PO check valve to ensure hydraulic fluid in each actuator will not be pushed out when the door plug load is applied to the actuators. To disengage latches, the valve opens and the actuators move in the opposite direction.

More specifically, with a twist lock hard capture system, in an exemplary embodiment, a high-level sequence of actions/events may include:

confirming soft capture sequence completed;

begin latch engagement sequence, extend, for example, approximately forty-five mm, twist ninety degrees, retract until contact is detected;

detect contact, including at least one of in-line hydraulic pressure reaching a threshold psi, and another sensor (e.g., inductive proximity sensor, laser sensor sensing an object within a threshold, x mm etc.), and confirm latch angle;

close valve of the hydraulic circuit to hold the actuator position;

door plug load is applied;

monitor cylinder hydraulic pressure increase;

door plug load is removed;

open valve of the hydraulic circuit; and

begin latch disengagement sequence, including extend to full stroke, twist ninety degrees, retract until dead end.

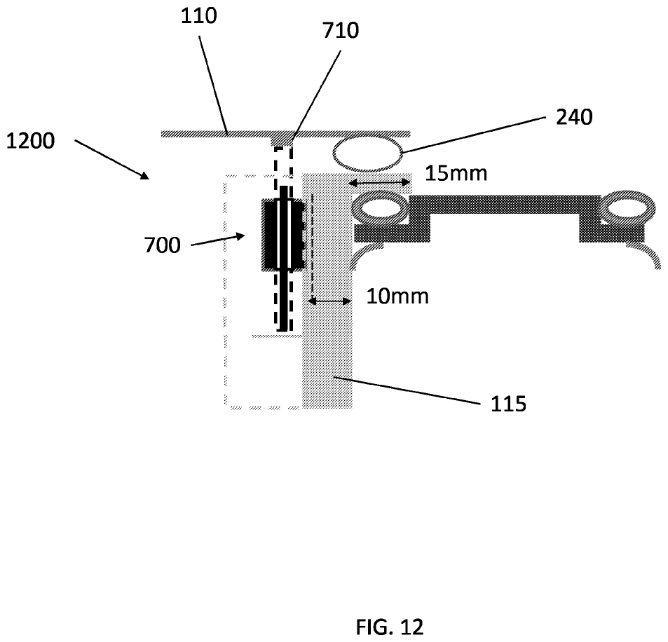

FIG. 12 shows an exemplary packaging 1200 of the twist lock hard capture system 700 in accordance with aspects of the disclosure. As shown in FIG. 12, the twist lock hard capture system 700 arranged on the airdock 115 engages with the catch 710 on the Pod 110 with a Pod dock seal 240 therebetween. As the twist lock hard capture system 700 utilizes an actuator that can actuate both rotationally and axially and is operable to extend linearly so as to actuate (and, for example, does not require and swinging motion), the packing 1200 for the twist lock system can be relatively small.

With an exemplary twist lock hard capture embodiment, the actuator extends by approximately 50 mm; at approximately 1″/sec, rotates by ninety degrees (<1 sec); retracts by approximately 10 mm until low load is detected; at 1″/sec, hold position while approximately 27 kN load is applied (some latches may see lower loads). With this exemplary twist lock hard capture embodiment, the actuator rod is hollow. With a rod diameter of approximately 12 mm, and approximately 3 mm radial clearance the inner diameter of the hollow actuator rod is approximately 18 mm. An exemplary latching system may have eight latches per side (for a total of sixteen latches).

As described herein, the twist lock hard capture latching system may operate with a directional valve with a piloted-operated (PO) check valve in each line. Also with the twist lock hard capture latch, the larger area side of the latch can be used for reacting the external load.

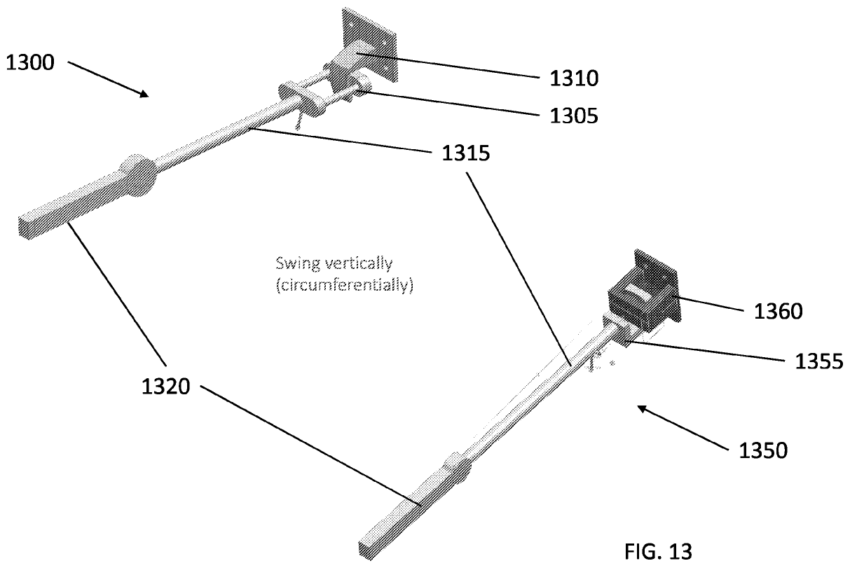

FIG. 13 shows exemplary and non-limiting latch assemblies 1300 and 1350 structured and arranged to swing the latch into the respective catch in accordance with aspects of the disclosure. For example, with latch assembly 1300, the latch assembly is structured to swing the latch 1305 vertically (or circumferentially) into the respective catch 1310. As shown in FIG. 13, with this exemplary embodiment, the catch 1305 is open and the latch 1305 is a closed loop. Latch assembly 1350 is also structured to swing the latch 1355 vertically (or circumferentially) into the respective catch 1360. As shown in FIG. 13, with this exemplary embodiment, the catch 1360 is a closed loop and the latch 1355 is an open loop.

With the swing lock embodiment, in an exemplary embodiment, a high-level sequence of actions/events may include:

confirming soft capture sequence completed;

begin latch engagement sequence, retract until contact is detected;

detect contact, including at least one of in-line hydraulic pressure reaching a threshold X psi, and another sensor (e.g., inductive proximity sensor, laser sensor sensing an object within a threshold, x mm etc.);

close valve of the hydraulic circuit to hold the actuator position;

door plug load is applied;

monitor cylinder hydraulic pressure increase;

door plug load is removed;

open valve of the hydraulic circuit; and

begin latch disengagement sequence, including extend to full stroke, twist ninety degrees, retract until dead end.

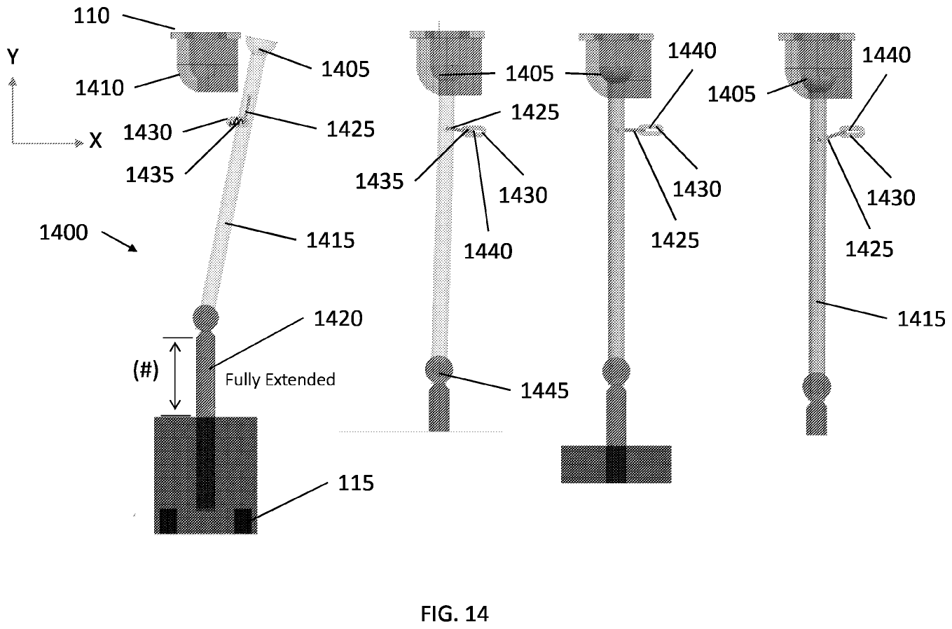

FIG. 14 shows an exemplary 4-bar linkage (sliding) hard capture latching system 1400 in accordance with aspects of the disclosure. As shown in FIG. 14, the 4-bar linkage (sliding) hard capture latching system 1400 is arranged on the airdock 115 engages with the catch 1410 on the Pod 110. The 4-bar linkage (sliding) hard capture latching system 1400 includes semi-grounded link 1425, which can slide in the x-direction, a slotted link 1430 having a slot 1440 therein, in which the semi-grounded link 1425 can slide. A spring 1435 is arranged in the slot 1440 for urging the semi-grounded link 1425 in the x-direction (without applied force, the semi-grounded link 1425 is pushed rightwards). An actuator 1420 is attached to the latch arm 1415.

As shown on the left hand side of FIG. 14, in an unlatched condition the latch arm 1415 is away from the capture 1410, the actuator 1420 is extended (e.g., fully extended), the semi-grounded link 1425 is shifted to the right in the slot 1440 of the slotted link 1430, and the spring 1435 is extended (uncompressed, e.g., 3 mm). As shown in the next condition, the actuator 1420 retracts the latch arm 1415, the semi-grounded link 1425 slides leftward in the slot 1440 of the slotted link 1430, and the spring 1435 is partially compressed. As this occurs, the latch arm 1415 pivots around pivot joint 1445 and begins to contact the catch 1410. As shown in the next condition, the actuator 1420 further retracts the latch arm 1415, the semi-grounded link 1425 slides fully leftward in the slot 1440 of the slotted link 1430, and the spring 1435 is fully compressed (i.e., 0 mm). As this occurs, the latch arm 1415 further pivots around pivot joint 1445 and the sphere of the latch 1405 contacts the socket of the catch 1410. As shown in the final (or optional) condition, the actuator 1420 further retracts the latch arm 1415 (e.g., 6 mm), the semi-grounded link 1425 pivots downwardly in the slot 1440 of the slotted link 1430, the spring 1435 remains fully compressed, and the seals are further compressed to complete the hard capture process. In accordance with further aspects of the disclosure, to disengage the 4-bar linkage (sliding) hard capture latching system 1400, the actuator 1420 is extended and the spring 1435 is operable to push the latch 1405 of the latch arm 1415 out of the catch 1410.

In order to provide variance accommodation, the linkage lengths for X may be adjusted. In embodiments, circumferential alignment may be achieved by bending the arm (low stiffness) or by floating the Pod catch. The low contact stress (ball and socket with almost matching diameters) may require service and the guide taper may wear over time. With the exemplary 4-bar linkage (sliding) hard capture latching system 1400 the top latch location might be modified for suitable packaging, wherein the catch profile height may be approximately 35 mm.

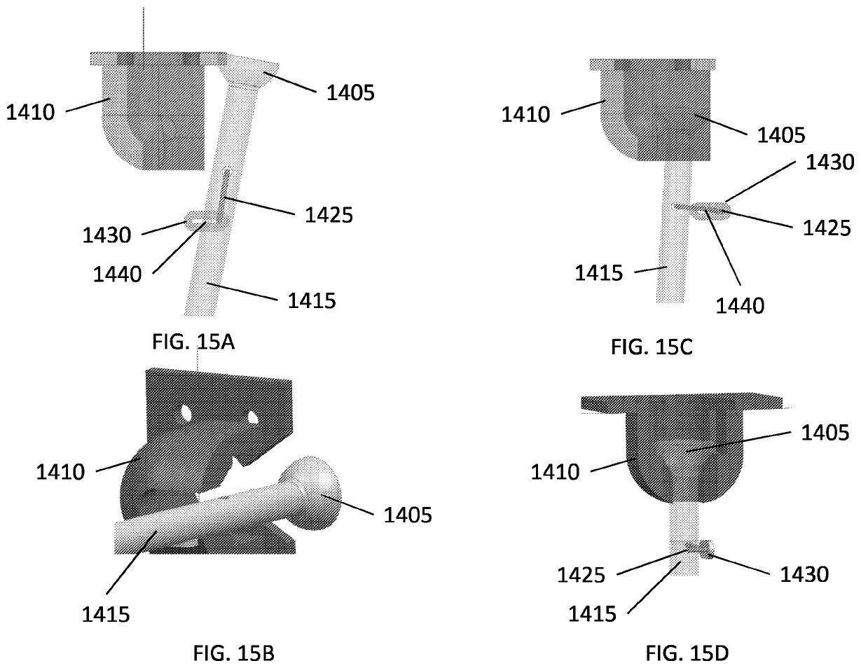

FIGS. 15A-15D show various views of elements of the 4-bar linkage (sliding) hard capture latching system 1400 in accordance with aspects of the disclosure. As shown in the sectional view of FIG. 15A, in an unlatched condition the latch arm 1415 and latch 1405 are away from the catch 1410 and the semi-grounded link 1425 is shifted to the right in the slot 1440 of the slotted link 1430 and pivoted upwardly. As shown in FIG. 15B, in an unlatched condition the latch arm 1415 and latch 1405 are away from the catch 1410. As shown in the sectional view of FIG. 15C, in an improperly-latched (or stuck) condition, the latch arm 1415 and latch 1405 are not in proper seated position in the catch 1410, but rather the latch 1405 is in contact with an edge of the seat of the catch 1410, and the semi-grounded link 1425 remains shifted to the right in the slot 1440 of the slotted link 1430 as it is pivoted downwardly (instead of the semi-grounded link 1425 shifting leftwardly in the slotted link). FIG. 15D shows the locked position of the 4-bar linkage (sliding) hard capture latching system 1400. As shown in the perspective view of FIG. 15D, the semi-grounded link 1425 is fully rearward (from this perspective) in the slot of the slotted link 1430, the latch arm 1415 has moved within the catch 1410, the latch 1405 contacts the socket of the catch 1410, and the latch arm 1415 is retracted so that the seals are further compressed to complete the hard capture process.

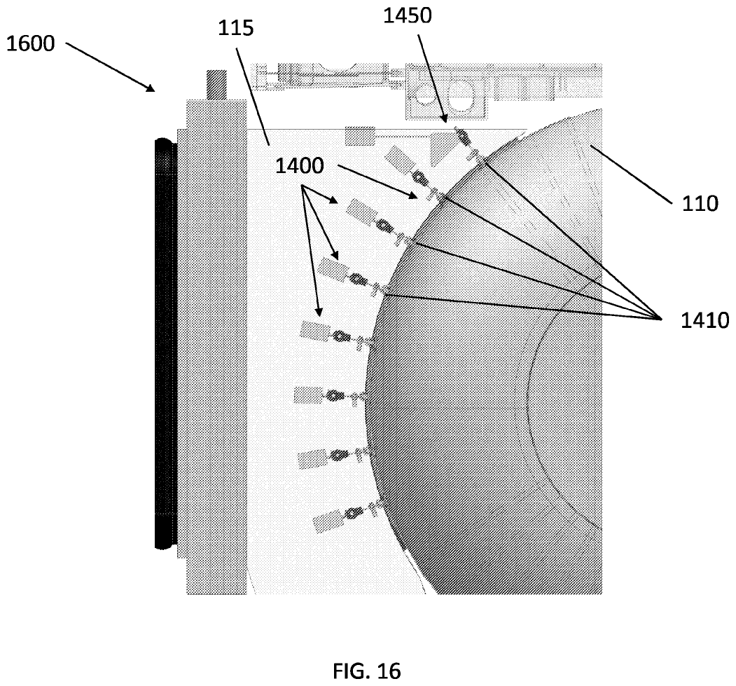

FIG. 16 shows an exemplary layout 1600 (location and orientation) of the 4-bar linkage (sliding) hard capture latching system 1400 (including respective actuators) on an airdock 115 and engaged with respective catches 1410 of a Pod 110 in accordance with aspects of the disclosure. With an exemplary embodiment, all of the latches around the door (or in an alternative embodiment, latches on one side of the door) may be on a common hydraulic circuit, and opening and closing the valve to the circuit actuates the latches. As noted above, with the exemplary 4-bar linkage (sliding) hard capture latching system 1400 the top latch assembly 1450 might be modified (compared to other latch assemblies 1400) for suitable packaging within the airdock 115, wherein the catch profile height may be approximately 35 mm.

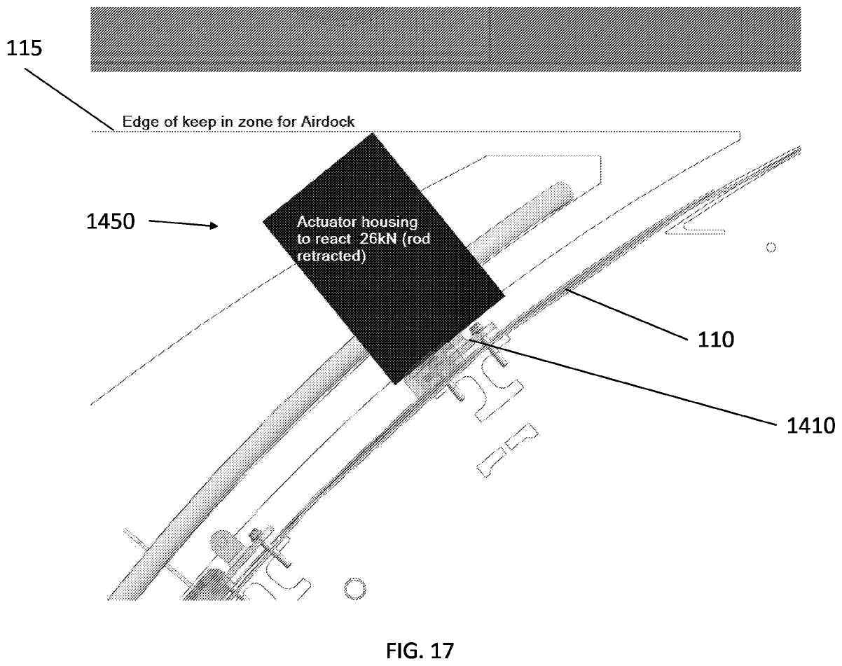

FIG. 17 shows an exemplary schematically-depicted top latch assembly 1450 in an airdock 115, wherein the top latch assembly 1450 is modified for suitable packaging within an upper region of the airdock 115, wherein the catch profile height may be approximately 35 mm (shown by the edge of keep in the zone for the airdock). That is, as shown in FIG. 17, the top latch assemblies 1450 are in an area of the airdock 115 with reduced space arranged facing the Pod 110. As such, the modified top latch assembly 1450 (schematically depicted) is used in the reduced-space regions within the airdock 115 to engage with the corresponding upper catches 1410. As also shown in FIG. 17, with an exemplary embodiment, the top latch assembly 1450 is operable to react to a twenty-six kN force (e.g., when the rod is retracted).

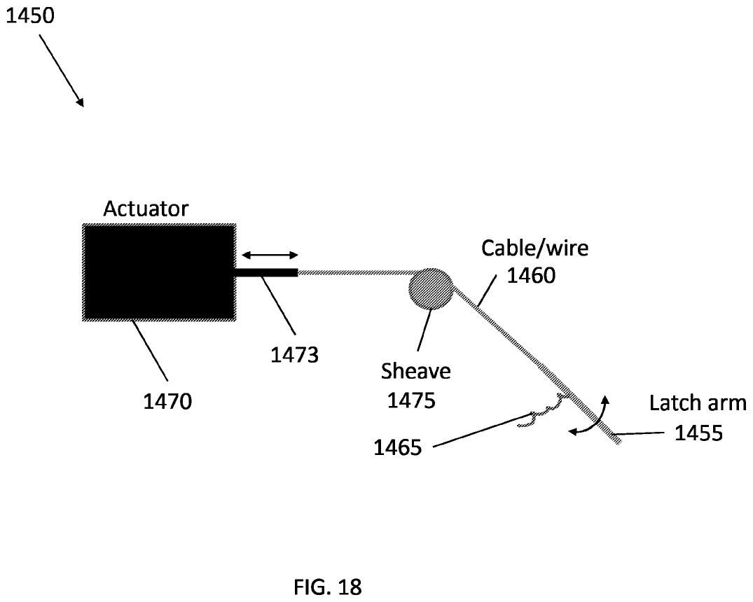

FIG. 18 shows an exemplary top latch assembly 1450 for an exemplary hard capture latching system in accordance with aspects of the disclosure. As shown in FIG. 18, the top latch assembly 1450 includes an actuator 1470 operable to retract (and extend) a rod 1473 in direction of arrow, which is connected to a cable/wire 1460 around a sheave 1475. A latch arm 1455 is attached to the end of the cable/wire 1460 and a spring 1465 is arranged between a housing (not shown) of the top latch assembly 1450 or a wall of the airdock (not shown) and the latch arm 1455. In accordance with aspects of the disclosure, the spring 1465 is operable to keep the desired angle of the latch arm when not engaged (round double-sided arrow). Without spring, the latch arm might want to sag due to gravity. When the actuator 1470 retracts the rod 1473, the latch arm 1455 is moved in one direction of arrow into an engagement position with the respective catch (not shown). When the actuator 1470 extend the rod 1473, the latch arm 1455 is moved in other direction of arrow out of an engagement position with the respective catch (not shown). Other than the sheave 1475 and the cable 1460, the rest of the latch operation of this exemplary embodiment is similar to the side way swing embodiments of FIGS. 13-15.

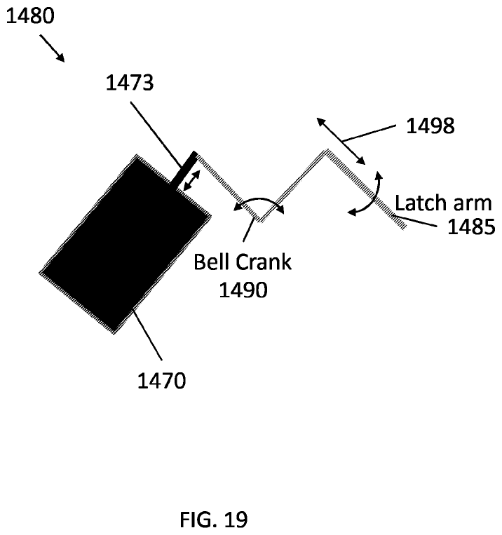

FIG. 19 shows another exemplary top latch assembly 1480 for an exemplary hard capture latching system in accordance with aspects of the disclosure. As shown in FIG. 19, with this exemplary embodiment, the top latch assembly 1480 includes an actuator 1470 operable to retract (and extend) a rod 1473 in direction of arrow. The end of the rod is connected to a first end of a bell crank 1490 operable to pivot in direction of arrow. The second end of the bell crank 1490 is connected a latch arm 1485. In accordance with aspects of the disclosure, when the actuator 1470 retracts, the bell crank 1490 is pivoted counterclockwise so as to pull the latch arm in the direction of arrow 1498 to retract the latch arm 1485 in one direction of arrow 1498 away from an engagement position with the respective catch (not shown). When the actuator 1470 extends, the bell crank 1490 is pivoted clockwise so as to extend the latch arm 1485 in other direction of arrow 1498 into an engagement position with the respective catch (not shown). As shown in FIG. 19 (with curved arrow around latch arm 1485), some rotation of latch arm 1485 is expected when the latch arm 1485 is retracted and extended. As compared to the top latch assembly 1450 of FIG. 18, the top latch assembly 1480 of FIG. 19 (and specifically, the bell crank 1490) may increase a misalignment vector of the top latch assembly 1480 by approximately a factor of two. The latch operation of this exemplary embodiment is similar to the side way swing embodiments of FIGS. 13 15.

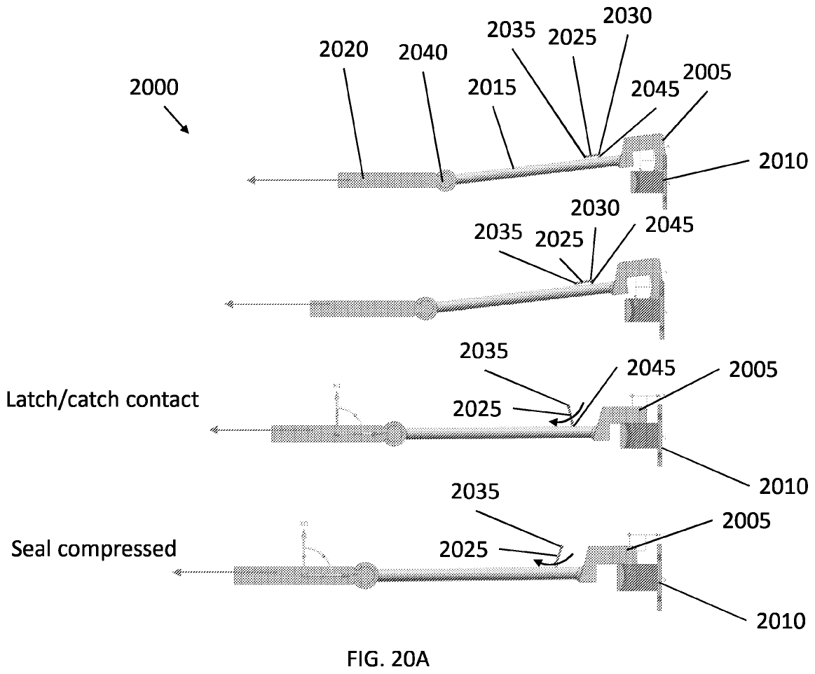

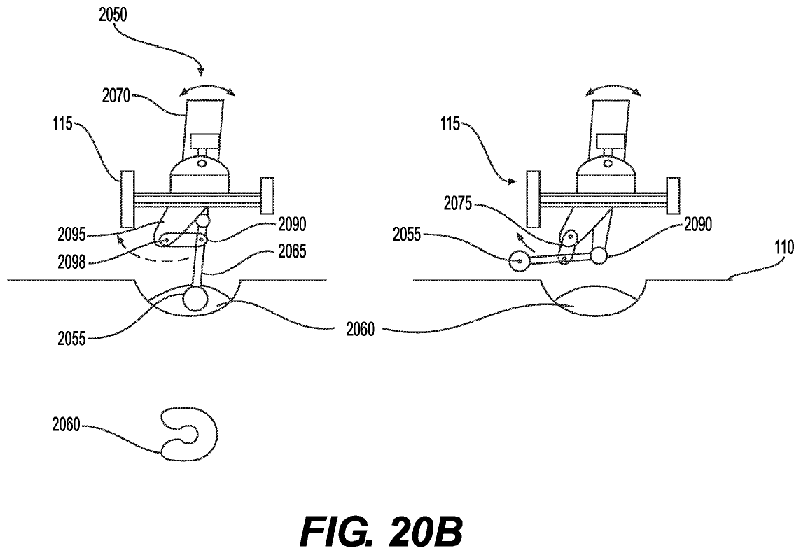

FIG. 20A shows an exemplary 4-bar linkage (circumferential swing) hard capture latching system 2000 in accordance with aspects of the disclosure. As shown in FIG. 20A, the 4-bar linkage (circumferential swing) hard capture latching system 2000 includes an actuator 2020 operable to retract (in direction of arrow) and extend, a latching arm 2015 attached to the actuator 2020 via a pivotable connection 2040. A first end of a grounded linkage 2025 is connected to the latching arm 2015 at pivotable connection 2045 and the second end of the grounded linkage 2025 is connected to the airdock (not shown) at pivotable connection 2035. As shown in FIG. 20A, a latch 2005 is provided at the end of the latching arm 2015, and the latch 2005 is structured and arranged to be accommodated in the catch 2010 attached to the Pod (not shown). As shown in the top position of FIG. 20A, the 4-bar linkage (circumferential swing) hard capture latching system 2000 is beginning a latching process as the actuator 2020 begins to retract in the direction of the arrow. As shown in the second position of FIG. 20A, the latching process continues as the actuator 2020 continues to retract in the direction of the arrow. As shown in the third position of FIG. 20A, in accordance with aspects of the disclosure, as the actuator 2020 continues to retract, the grounded linkage 2025 induces a circular motion in the latch arm 2015 in the direction of the arrow, which enables the contact between the latch 2005 and the catch 2010. As shown in the bottom position of FIG. 20A, with further retraction of the actuator 2020, the latch is retracted further so as to compress the seal or seals (not shown) between the Pod and the airdock. As the seal (not shown) is compressed, the latch/catch contact point may slightly change as the latch moves in a circular motion, but the position change should be minimal as the motion path of the latch arm 2005 is almost straight. Similar to the above-discussed embodiments, the top latch (and/or the top latch location) may need to be modified in view of the reduced spacing at the top latch, wherein a catch profile height may be approximately 55 mm. With this exemplary embodiment, circumferential variation may be accommodated by geometry (e.g., increasing diameters) and axial variation may be accommodated by increasing the catch width.

FIG. 20B shows another exemplary four-bar linkage (circumferential swing) hard capture latching system 2050 in accordance with aspects of the disclosure. As shown in FIG. 20B, the four-bar linkage (circumferential swing) hard capture latching system 2050 includes an actuator 2070 operable to retract and extend, a latching arm 2065 attached to the actuator 2070 via a pivotable connection 2090. A first end of a grounded linkage 2075 is connected to the latching arm 2065 at pivotable connection 2090 and the second end of the grounded linkage 2075 is connected to the airdock (via arm 2095) at pivotable connection 2098. As shown in FIG. 20B, a latch 2055 is provided at the end of the latching arm 2065, and the latch 2055 is structured and arranged to be accommodated in the catch 2060 attached to the Pod 110.

In accordance with aspects of the disclosure, as the actuator 2070 retracts, the grounded linkage 2075 induces a circular motion in the latch arm 2015, which enables the contact between the latch 2055 and the catch 2060. With further retraction of the actuator 2070, the latch 2055 is retracted further so as to compress the seal or seals (not shown) between the Pod 110 and the airdock 115.

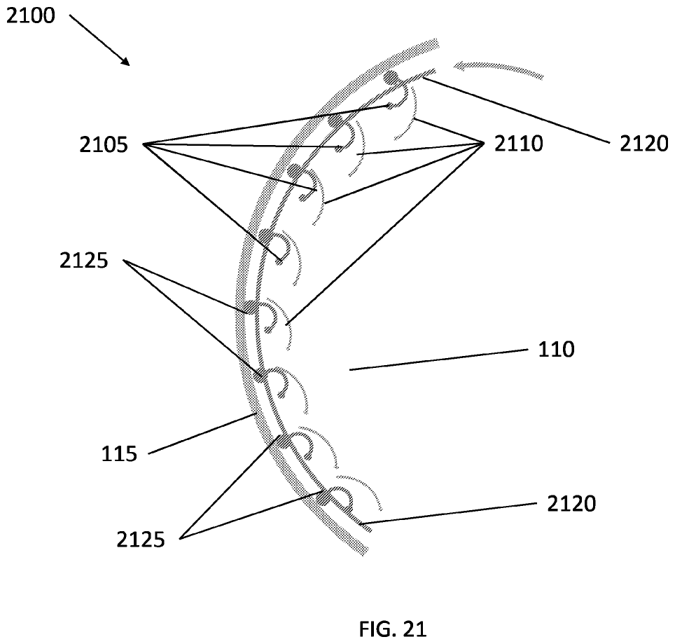

FIG. 21 shows an exemplary belt drive hard capture latching system 2100 in accordance with aspects of the disclosure. With the belt drive hard capture latching system 2100, a belt drive 2120 is operable to swing (or rotate around pivots 2125) all of the latches 2105 arranged on the airdock 115 into engagement with the respective catches 2110 arranged on the Pod 110 simultaneously. With this embodiment, the packaging is good, as the belt drive hard capture latching system 2100 is compact. Variance accommodation may be difficult with this embodiment, however, as the belt drive hard capture latching system 2100 depends upon geometry.

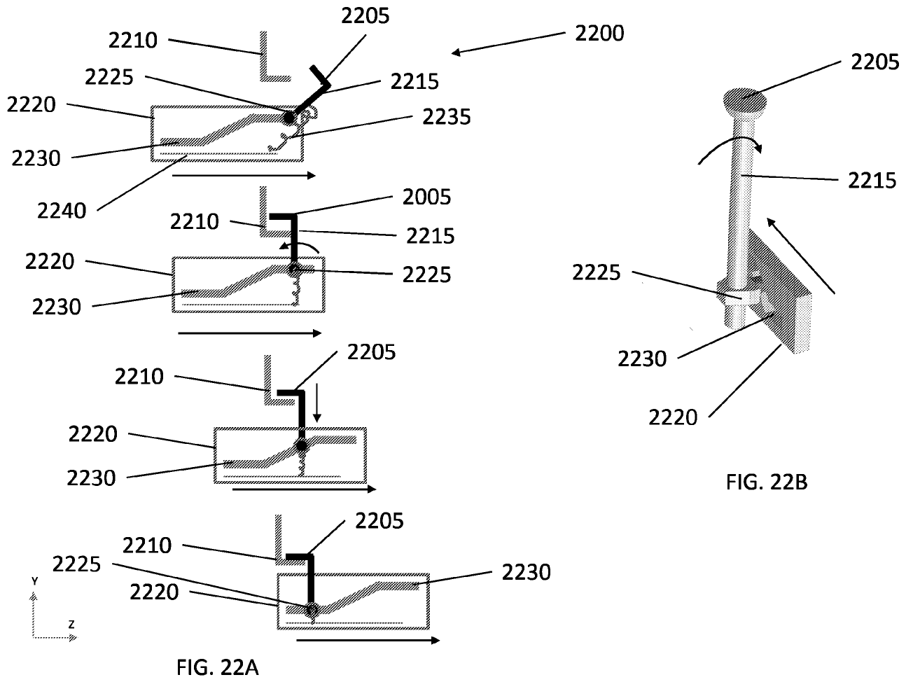

FIG. 22A shows an exemplary track follower hard capture latching system 2200 in an unlatched condition, a latched condition and various stages therebetween in accordance with aspects of the disclosure. As shown in FIG. 22A, the track follower hard capture latching system 2200 includes a track actuator 2220 operable to move rightward (in direction of horizontal arrow) to actuate the latch 2205 into a latching position on the catch 2210, and leftward (in direction opposite to horizontal arrow) to actuate the latch 2205 into an unlatched position on the catch 2210. More specifically, as shown in FIG. 22A, the track actuator 2220 includes a track 2230, and a latch arm 2215 has a first end forming the latch 2205 and a second end (track follower) 2225 operable to slide in the track 2220. Additionally, the track actuator 2220 includes a spring track 2240, and a spring 2235 is arranged with a first end attached to the latch arm 2215 and a second end operable to slide in the spring track 2240.

As shown in the top position of FIG. 22A, the latch 2205 is positioned away from the catch 2210 and the track follower hard capture latching system 2200 is in an unlatched position. The spring track 2240 does not extend as far rightward as the track 2230. As such, in the top position of FIG. 22A, when the latch arm 2215 is fully right-ward in the track 2230, the spring 2235 is operable to pull and rotate the latch arm 2215 (and latch 2205) away from the catch 2210.

As shown in the next position of FIG. 22A, as the track actuator is moved rightward (in direction of arrow), the track follower 2225 of the latch arm 2215 is operable to follow the track 2230. At this next position, when the latch arm 2215 is in a position in the track 2230 approximately immediately above the end of the spring track 2240, the spring 2235 is operable to rotate the latch arm 2215 (in the direction of rotational arrow) to a vertical orientation, such that the latch 2005 is arranged above the catch 2210.

As shown in the next position of FIG. 22A, as the track actuator 2220 is moved further rightward, the track follower 2225 of the latch arm 2215 continues to follow the track 2230 as the track diverges downwardly. As this occurs, the latch arm 2215 is moved vertically downward (in direction of vertical arrow), and the latch 2205 is moved toward the catch 2210.

As shown in the last position of FIG. 22A, as the track actuator 2220 is moved further rightward, the track follower 2225 of latch arm 2215 continues to follow the track 2230, and the latch arm 2215 is further moved vertically downward such that the latch 2205 is moved into latching engagement with the catch 2210. In such a manner, the track follower hard capture latching system 2200 is operable to move between an unlatched condition and a latched condition. As should be understood, once in the latched condition, by moving the track actuator 2220 leftward, the track follower hard capture latching system 2200 is operable to move into the unlatched condition.

FIG. 22B shows portions of an exemplary track follower hard capture latching system 2200 in accordance with aspects of the disclosure. Specifically, FIG. 22B shows a track actuator 2220 having a track 2230 and shows the latch arm 2215 having the track follower 2225 engaged in the track 2230 and the latch 2205 on the opposite end of the latch arm 2215. In accordance with aspects of the disclosure, as the track actuator 2220 is moved rearwardly (in direction of straight arrow), the latch arm 2215 is operable to rotate upwardly (in direction of rotational arrow) to position shown in FIG. 22B and then shift downwardly as the track follower 2225 moves in the track 2230.

With the track follower hard capture latching system 2200 the track actuator 2220 can be moved in z-position by a set distance or move until a certain amount of load is detected (e.g., with load or pressure sensors). With this exemplary embodiment, the load could be reacted by utilizing the rigid structure of the track follower hard capture latching system 2200. Alternatively, the load could be reacted by using a hydraulic system if the latch is configured to slide in the y-direction after the z-position is set. Variance could be accommodated by configuring the latch to float in the x-direction. Additionally, circumferential variation may be accommodated by geometry (e.g., making socket larger).

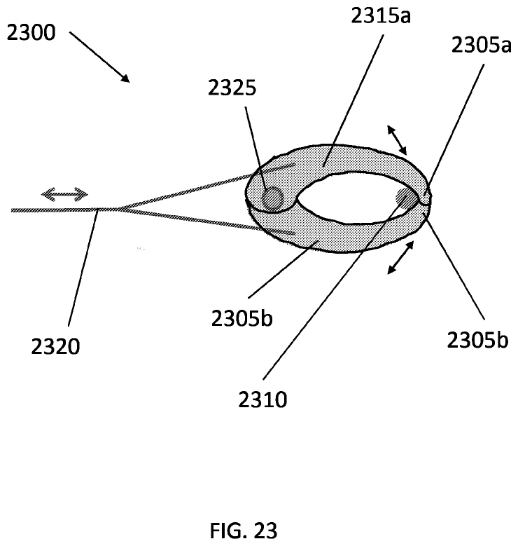

FIG. 23 shows an exemplary dual jaw latch hard capture latching system 2300 in accordance with aspects of the disclosure. As shown in FIG. 23, with the dual jaw latch hard capture latching system 2300, two jaws 2315a, 2315b having respective latch ends 2305a, 2305b are operable to close around a catch 2310 to balance tangential loads from varying engagement angles in accordance with aspects of the disclosure. More specifically, as the actuator 2320 moves rightward, the actuator 2320 is operable to move (e.g., pivot) each of the two jaws 2315a, 2315b around the pivot connection 2325 so that the respective latch ends 2305a, 2305b are moved (see direction of angled lines) into a latching position (shown in FIG. 23). As the actuator 2320 moves leftward, the actuator 2320 is operable to move (e.g., pivot) each of the two jaws 2315a, 2315b around the pivot connection 2325 so that the respective latch ends 2305a, 2305b are moved (see direction of angled lines) away from the latching position. With this exemplary embodiment, the circumferential motion and catch profile may be relatively low, which permits better packaging of the dual jaw latch hard capture latching system 2300. As with other embodiments, however, the top latch may need to be modified (e.g., due to spacing constraints) and this may also depend upon how the load is reacted. Variance in the x-direction could be accommodated by increasing width of the dual jaw latch hard capture latching system 2300. Additionally, circumferential variation may be accommodated by geometry.

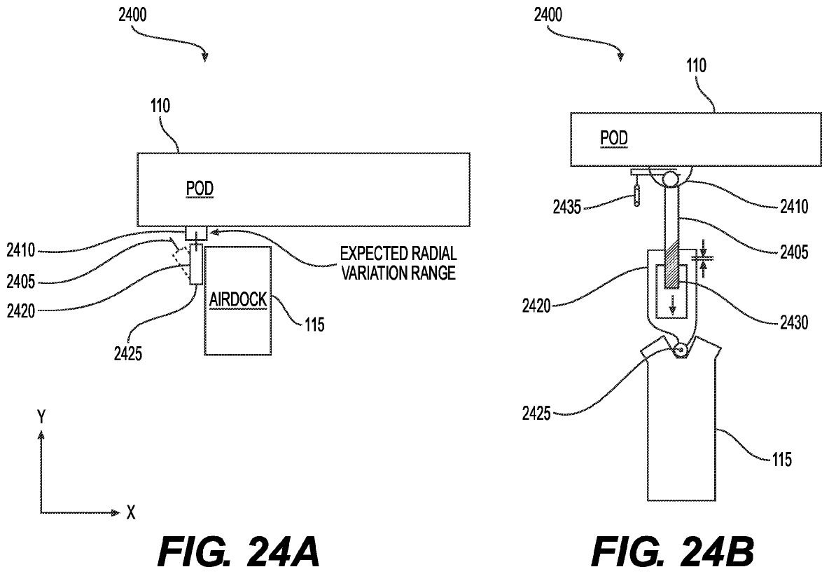

FIGS. 24A and 24B show an exemplary schematic a known-length swing latch hard capture system 2400 in accordance with aspects of the disclosure. With this exemplary embodiment, latches 2405 of a known length are connected to a stiff structure with ball joints. As shown in dashed lines in FIG. 24A, the latches 2405 on the structure are oriented away from the Pod 110 in an unengaged position so they are out of the way of the Pod 110. Once soft capture is complete, as shown in FIG. 24A, the latch actuator 2420 is rotated (e.g., passively or actively) via pivot connection 2425 with the airdock 115 so that the latches 2405 are swung into the respective Pod catches 2410. In embodiments, the catch 2410 may have a lead-in chamfer 2435 to align the latch 2405. The latches 2405 are then retracted via retraction mechanism 2430 of the latch actuator 2420 to ensure contact between latch 2405 and catch 2410 (e.g., with some small load) and latch positions are locked out completing the hard capture process. With this exemplary embodiment, variance accommodation (e.g., to accommodate any misalignment) may be achieved, for example, using ball joints. FIG. 24A also shows an expected radial variation range for the catch 2410.

In accordance with aspects of the disclosure, contact of each latch and catch pair needs to be confirmed before the door opens. In embodiments, detecting contact of each latch and catch pair may include building up a certain level of pressure much less than the pressure under full door plug load in the actuator before confirming latch engagement. This approach is simple to implement. If there is a debris that can withstand the initial load but collapses under the full door load, however, the Pod fuselage may deflect by the thickness of the debris. Other latches may be overloaded as well. With another approach, a Hall effect sensor may be arranged on the latch arm to detect distance to the catch. Advantages of this approach are that the sensor could be compact. However, cable management and/or packaging may be challenging and this approach may require tight machining, assembly tolerances. With yet another approach, an inductive proximity/laser sensor may be used to confirm latch engagement. An inductive proximity/laser approach, however, may not be compact, and cable management, packaging can be challenging as it may require tight machining and assembly tolerances.

With another approach, the latch-catch contact may be a switch, wherein proper contact is confirmed if measured resistance/magnetic reluctance is less than a threshold, X. If there is metal/ferritic debris, however, such debris could interfere with the measured resistance or reluctance. Yet another approach to confirm latch engagement is to compare expected “interstitial volume pressure to force curve” to measured pressure to force curve. If deviation is detected, then the valve that supplies air to the interstitial volume may be closed. This approach is advantageous, as it does not require additional hardware. However, nothing may be detected until the fuselage deflects by a certain amount and/or response time might not be fast enough for ideal operation of the Pod.

### Reacting Door Load

Additional aspects of the disclosure are directed to reacting the door load once hard capture is achieved and pressure equalization is commenced. In embodiments, the door load may be reacted, for example, by utilizing a stiff structure, a hydraulic circuit, a lead screw, and/or spring balancing.

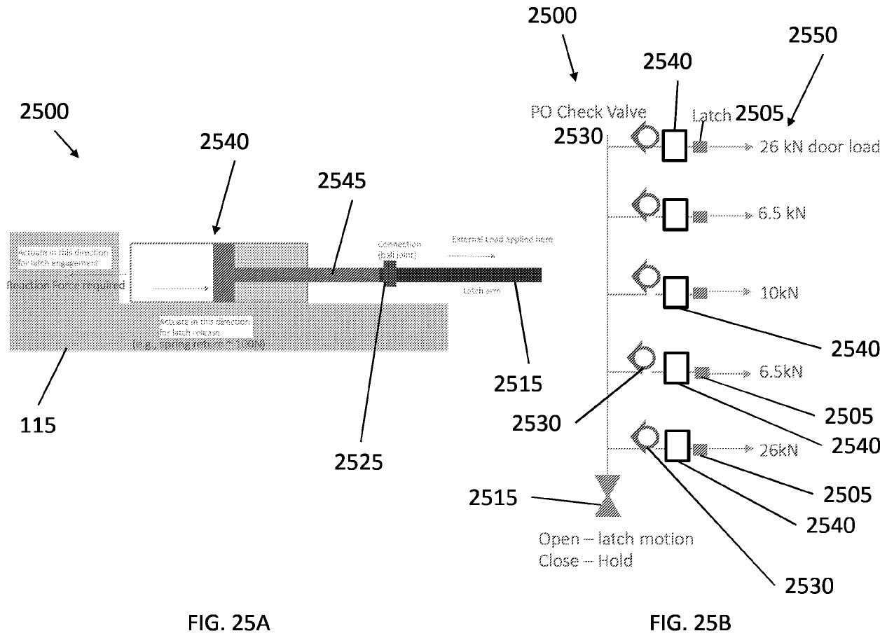

FIGS. 25A and 25B show schematic views of an exemplary latch hydraulic circuit 2500 for reacting the door load once hard capture is achieved and pressure equalization is commenced in accordance with aspects of the disclosure. As shown in FIGS. 25A and 25B, the latch hydraulic circuit 2500 may be arranged on the airdock 115, and includes a valve 2515 and a plurality of respective hydraulic actuators (or cylinders) 2540 (only one shown in FIG. 25A) connected to a respective latch arm 2515 via a connection (e.g., ball joint 2525). The end of each latch arm 2515 includes a respective latch 2505.

The latch hydraulic circuit 2500 is operable to control an array of latches all on one hydraulic circuit. With an exemplary embodiment the latching motion may require 100N, and the latch hydraulic circuit 2500 may need to resist external force of 20-301 kN. All on one hydraulic circuit. In some embodiments, larger bore diameters may be utilized for latches requiring larger load capability. As it is important to ensure contact or small load before closing the valve, distance control and/or force control may be provided using, for example, a limit switch, linear position sensor, and/or a transducer with feedback loop. A larger accumulator could be used to reduce response time for pressure to equalization. In embodiments, the motion of the respective latches does not need to be synchronous.

In accordance with aspects of the disclosure, the latch hydraulic circuit 2500 can ensure contact between the catch (not shown) and latch 2505 before opening the airdock door. Once the door opens, the expected latch load will be applied and the catch position will not change, thus ensuring hard capture.

The process for operating the latch hydraulic circuit 2500 includes opening the valve 2515 to retract the respective hydraulic actuators 2540 (only one shown in FIG. 25A) to engage the respective latches 2505. Then the valve 2515 is closed. Next, the door opens and door load is applied to the actuator rod 2545. Next, the load is removed, the valve opens and the respective actuators 2540 extend to disengage the respective latches 2505.

As shown in FIG. 25B, the pilot-operated (PO) check valve 2530 in each line for each respective latch maintains the hydraulic fluid in the cylinder 2540, increasing the fluid pressure. At this point, in accordance with aspects of the disclosure, the latch hydraulic circuit 2500 is operable to accommodate varying fluid pressures from cylinder to cylinder due to varying loads 2550 at each of the latches 2505.

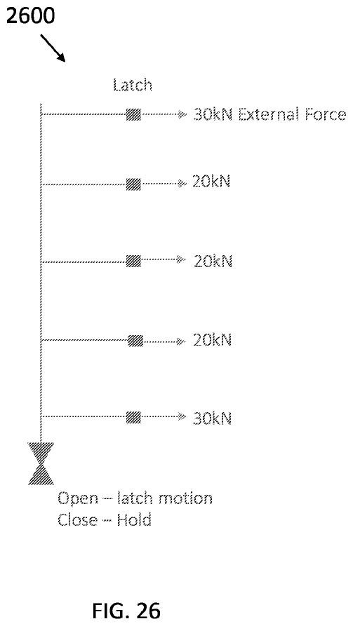

FIG. 26 show another exemplary latch hydraulic circuit 2600 for reacting the door load once hard capture is achieved and pressure equalization is commenced in accordance with aspects of the disclosure. As shown in FIG. 26, the latch hydraulic circuit 2600 does not include check valves. The latch hydraulic circuit 2600 operates in a similar manner to latch hydraulic circuit 2500 described above.

In some embodiments, lead screws may also be used for reacting the door load once hard capture is achieved and pressure equalization is commenced. For example, lead screws may be used to engage the latches and to react the door load. Once latch engagement is detected (e.g. small load), the lead screws are locked out to prevent further movement (for hard capture). In accordance with aspects of the disclosure, the screw position is maintained due to screw thread friction.

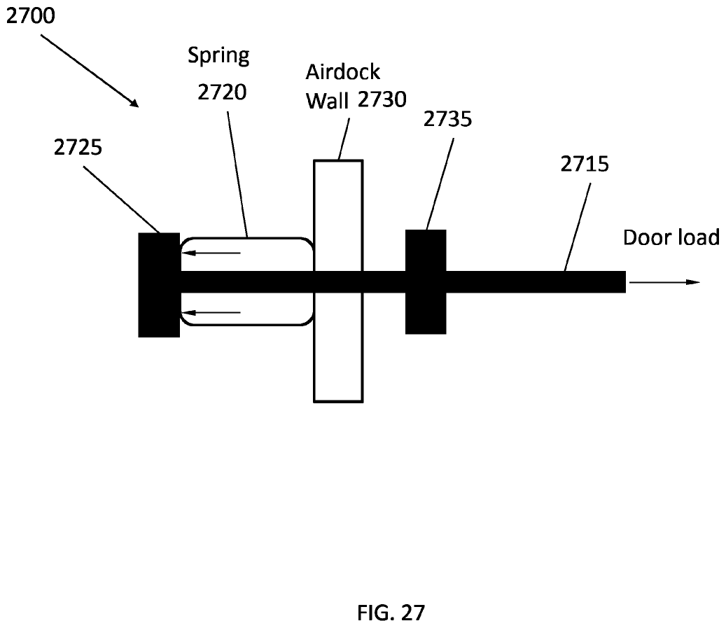

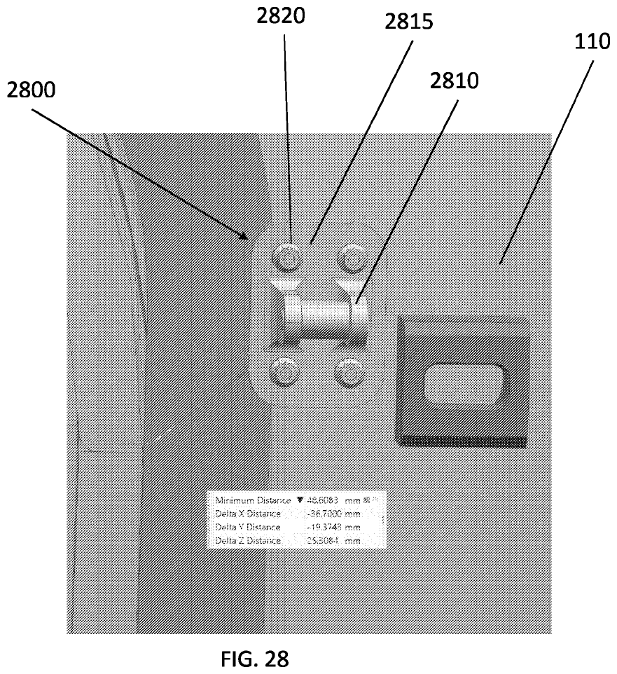

FIG. 27 shows an exemplary spring-balanced latch assembly 2700 for reacting the door load once hard capture is achieved and pressure equalization is commenced in accordance with aspects of the disclosure. As shown in FIG. 27, the spring-balanced latch 2700 includes a latch arm (or bar) 2715 with a latch (not shown) on one end thereof. The latch arm 2715 passes through a wall 2730 of the airdock. The latch arm includes a spring engagement plate 2725 at an end thereof and on one side of the airdock wall 2730 and a stopper plate 2735 on the other side of the airdock wall 2730. Each latch assembly 2700 includes a spring 2720 (e.g., a low-rate, high compression spring) that preloads the latch assembly 2700 against a hard stop at marginally under the desired latch load. Once latches are engaged and pressure is offloaded, the net pressure load will unseat the stopper plate 2725 and allow the spring 2720 to set the load at each latch rather than geometry. If there is a gap between latch and catch, the Pod may locally deflect until it makes contact with the latch. In accordance with aspects of the disclosure, the low-rate spring 2720 will allow to Pod to move away from the airdock by Y=(Door Load−Preload)/Spring Rate.

FIG. 28 shows an exemplary and non-limiting catch assembly 2800 on a Pod 110 in accordance with aspects of the disclosure. As shown in FIG. 28, the catch assembly 2800 includes a base plate 2815 attached via fasteners 2820 (e.g., bolts, rivets, etc.) to the outer surface of the Pod 110. Additionally, the catch assembly 2800 includes the catch 2810 configured to interact with a corresponding latch (not shown).

In an exemplary embodiment, the catch assembly 2800 may be arranged approximately 35 mm away from the Pod door edge. With an exemplary embodiment, the catch assembly 2800 may have a width of approximately 54 mm, a height of approximately 75 mm, and a depth of approximately 25 mm. As should be understood, a smaller depth dimension (i.e., a smaller protrusion from the Pod body) is desired so as to decrease undesired interference between the Pod and the wayside.

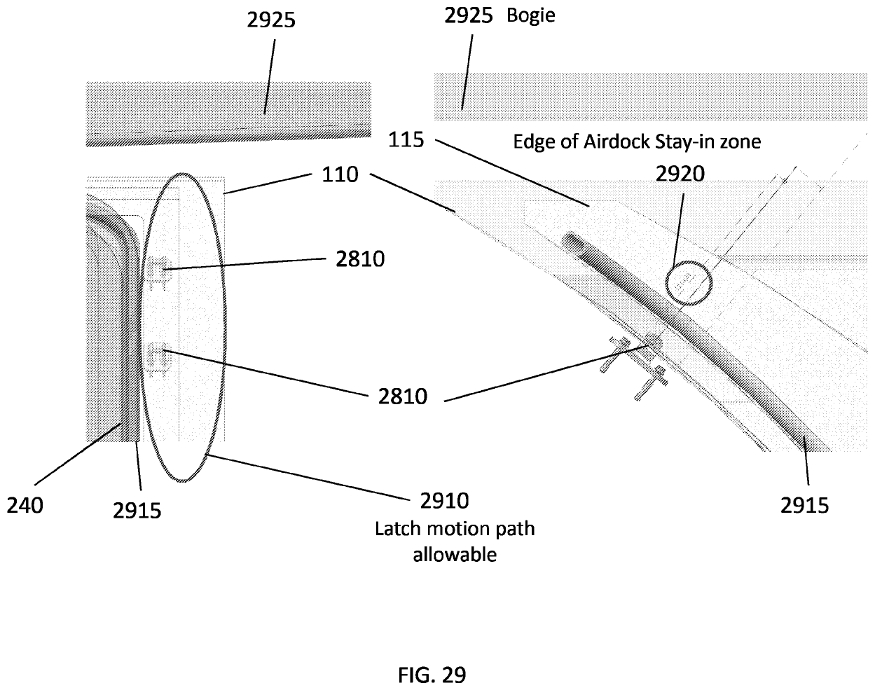

FIG. 29 shows exemplary side and section views of latch packaging considerations in accordance with aspects of the disclosure. As shown in the left hand view of FIG. 29, a Pod 110 has a number of catches 2810 on the side thereof configured for engagement with respective latches (not shown). An airdock-door seal 2915 is shown adjacent a Pod-airdock seal 240. This view also shows an exemplary allowable latch motion path 2910. As shown in FIG. 29, with this exemplary arrangement, the latching mechanism cannot swing inward (e.g. beyond the allowable latch motion path 2910), as such a motion would interfere with the seal (e.g., the airdock door seal 2915 and/or the adjacent a Pod-airdock seal 240.

As shown in the right-hand side view of FIG. 29, which shows the latch 2910 (e.g., top latch) in proximity to the bogie 2925 (or levitation system) of the Pod 110, the latching mechanism (not shown) (throughout its range of motion) should stay within the edge of airdock stay-in zone 2920. In an exemplary and non-limiting embodiment, a minimum radial space at the top latch location may be approximately 200 mm.

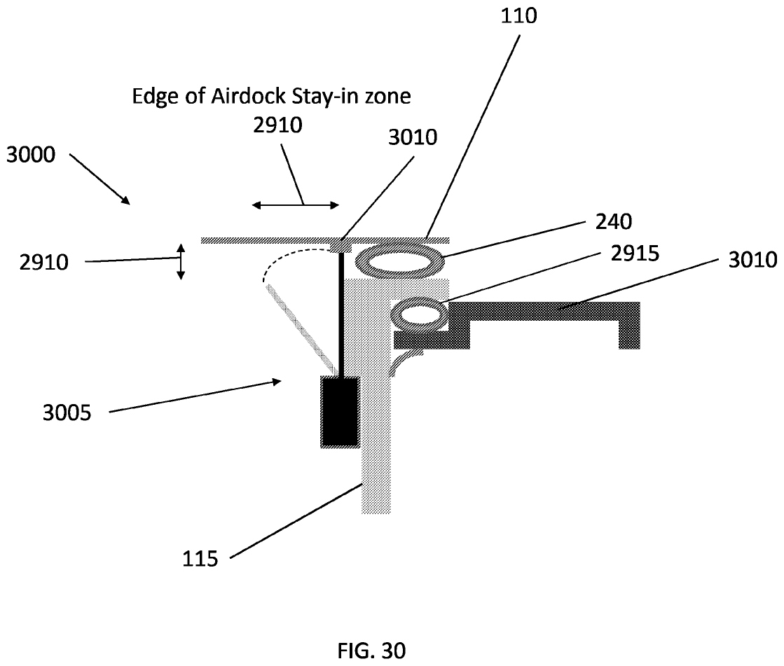

FIG. 30 shows an exemplary packaging 3000 of a four-bar linkage hard capture system 3005 (e.g., a bell crank hard capture system) in accordance with aspects of the disclosure. As shown in FIG. 30, the four-bar linkage hard capture system 3005 arranged on the airdock 115 engages with the catch 3010 on the Pod 110 with a Pod-airdock seal 240 there between. Since a larger actuator may be required, the actuator housing may protrude past the stay in zone 2910 (e.g., in the x- and/or y-direction), but such minimal protrusion should be acceptable. With an exemplary four-bar linkage hard capture embodiment, a catch height of the catch 3010 may be approximately 65 mm (including flange). In accordance with aspects of the disclosure, such a catch height is advantageous as it only adds 0.05% aero drag (e.g., negligible).

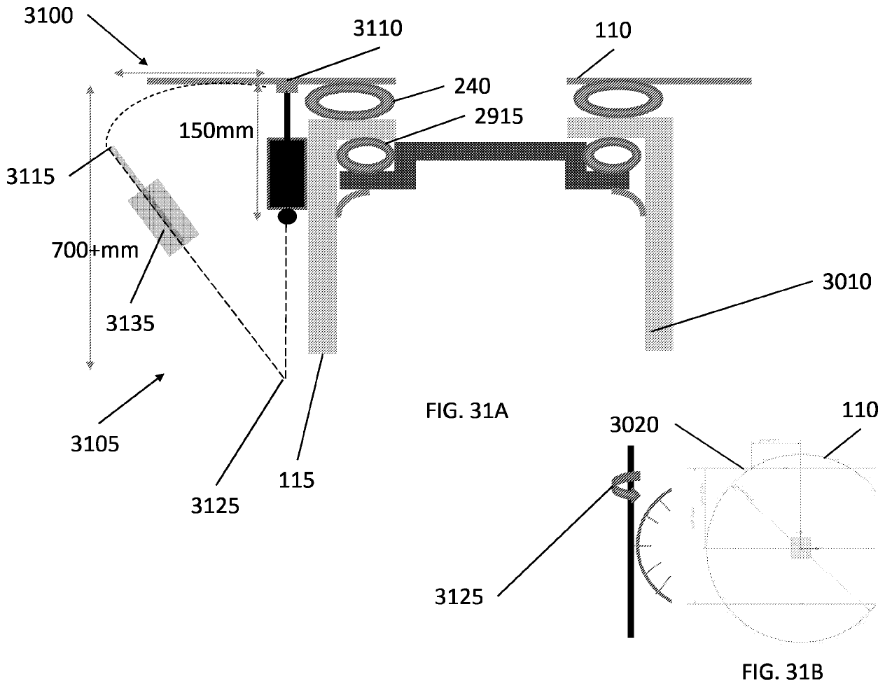

FIG. 31A shows an exemplary schematically-depicted packaging 3100 of a swing-of-known-length hard capture system 3105 at a cross section of the top latch location 3120 (as shown in FIG. 31B) in accordance with aspects of the disclosure. As shown in FIG. 31A, the latch 3115 of the swing-of-known-length hard capture system 3105 arranged on the airdock 115 engages with the catch 3110 on the Pod 110 with a Pod-airdock seal 240 there between.

As shown in FIG. 31A, since the latches 3115 are located along an arc, if all of them are swung into the catches together, the spin axis 3125 may be some distance (e.g., approximately 700+ mm) away from the top latch 3110. The airdock door seal width 2915 may be limited by the external dimensions (e.g. 150 mm) of the actuator/jack screw 3135 of the swing-of-known-length hard capture system 3105. In some embodiments, custom actuator/lead screw as the latch arm may be used. As shown in the exemplary depiction of FIG. 31A, the schematically-depicted packaging 3100 exceeds the stay-in zone limit and therefore might hit a roll rail (not shown) of the Pod 110.

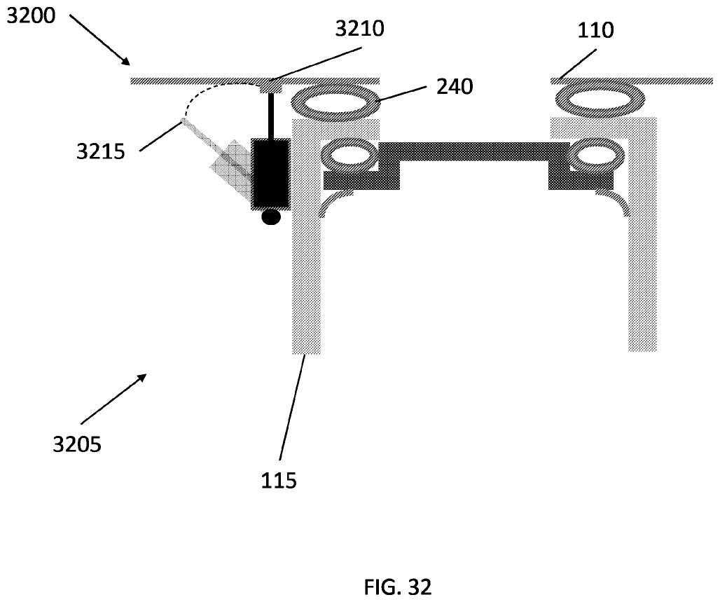

FIG. 32 shows another exemplary schematically-depicted packaging 3200 of a swing-of-known-length hard capture system 3205 at a cross section of the top latch location in accordance with aspects of the disclosure. As shown in FIG. 32, the latch 3215 of the swing-of-known-length hard capture system 3205 arranged on the airdock 115 engages with the catch 3210 on the Pod 110 with a Pod-airdock seal 240 there between. With this alternative embodiment, each latch can be swung into its respective catch by a common mechanism or individually. This embodiment is similar to the four-bar linkage embodiment described herein. The swing-of-known-length hard capture system 3205, however, may require two separate structures and/or mechanisms for the swinging and the engaging (e.g., retracting) motions (and thus, have twice as many actuators/jack screws as the four-bar linkage embodiment). Similar to other embodiments, the airdock door seal width may be limited with off-the-shelf parts and, alternatively, a custom actuator/lead screw may be used as the latch arm.

Thus, with a swing-of-known-length hard capture system, a custom actuator and/or lead screw may be required to provide a suitable airdock door seal width. The swing-of-known-length may utilize a closed loop motion control (e.g., swing until detect contact, then pull until detect contact). With respect to cycle time, the swing-of-known-length embodiment might require more time (e.g., with two separate steps—swing then pull). With a swing-of-known-length hard capture system, all of the latches (e.g., including top latch) could be the same, and variance accommodation may be accomplished radially using an actuator drawing back, and axially and/or circumferentially using a pivoting latch arm. With a swing-of-known-length hard capture system, it is possible to configure the latch engagement by comparing actuator positions. The latch may be falsely detected as engaged if some debris is stuck between the contact surfaces.

With a twist lock hard capture system, a custom actuator may be required to provide a suitable airdock door seal width. The twist lock hard capture system may utilize a passive or active rotary motion control. With respect to cycle time, the twist lock hard capture system might require more time (e.g., with three separate steps: extend, twist, retract). With the twist lock hard capture system, all of the latches (e.g., including top latch) could be the same (with some customization, for example), and variance accommodation may be accomplished radially using an actuator drawing back, and axially and/or circumferentially using a pivoting latch arm. With a twist lock hard capture system, it is possible to configure the latch engagement by comparing actuator positions.

With a four-bar linkage hard capture system, an off the shelf actuator may be used to provide a suitable airdock door seal width. The four-bar linkage hard capture system may utilize a passive swing motion control. With respect to cycle time, the four-bar linkage hard capture system might require less time than the other embodiments, for example, due to shorter travel distances. With a four-bar linkage hard capture system the top latch likely needs to be modified to stay within stay-in zone), and variance accommodation may be accomplished by deflection of the latch arm. With a four-bar linkage hard capture system, it is more challenging to configure the latch engagement by comparing actuator positions, as each latch could engage at a different axial angle due to the axial float.

### Seals

Embodiments of the disclosure may utilize one or more seals to ensure pressure is maintained in the airdock during stages of the Pod landing disembarkation process. Such seals may include solid cross section (o-ring) seals, which have a high compression load and an extremely low leak rate, but may be less accommodating of uneven compression (that may be experienced at the Pod/airdock engagement). Such seals may also include bulb seals, which have a low compression load, a low leak rate, and could still function as seal with minor damage (e.g., a small hole). Such seals may also include blade seals, which have a low compression load, a low leak rate, and could still function as seal with minor damage (e.g., a small hole). Such seals may also include inflatable seals, which have no compression load (as the seal is inflated to fill the gap) and a low leak rate. A small hole, however, may cause the seal to improperly function.

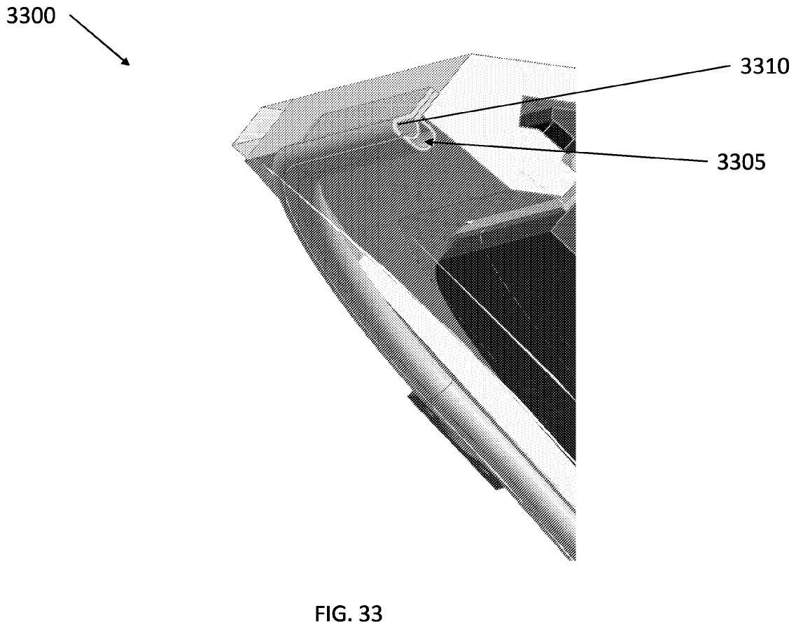

FIG. 33 shows an exemplary seal 3300 in accordance with aspects of the disclosure. As shown in FIG. 33, embodiments of the disclosure may also utilize a combination of seal types, e.g., a combination seal 3300 having a bulb seal 3305 and a blade seal 3310.

An exemplary embodiment utilizes inflatable seals to match the profile variations between the airdock and Pod fuselage sealing surface, with air as the actuation fluid, and operates between one and two atmospheres. The exemplary embodiment may utilize redundant isolated seals and 3-way, 3-position fail closed solenoid valves, for example. Assuming the Pod's approach to airdock is orderly, the seals are not expected to rub against the mating face. Thus, the seals may not need to be deflated (or may only require partially deflation) between each cycle to reduce cycle time. Regardless of the type of seals used or with/without deflating the inflatable seals during cycle, seal adhesion to the Pod skin should also be considered.

In embodiments, the seal should require low compression force especially between the airdock and Pod (and for the Pod door seal). The leak rate for airdock is assumed to be approximately 10 mg/s. In embodiments, the bulb seal operable to seal the gap, an airdock will likely require pressurization as the air trapped inside is expected to leak out into vacuum over time. With respect to seal materials, in some embodiments, the seal may be a silicone, which is generally good in vacuum (e.g., low TML), soft and compliant for low contact force, (heritage as the material for ISS docking seals). Silicone, however, has a high permeability and limited abrasion resistance. In other embodiments, the seal may be a EPDM, which is less permeable, more abrasion resistant, but less compliant and higher TML).

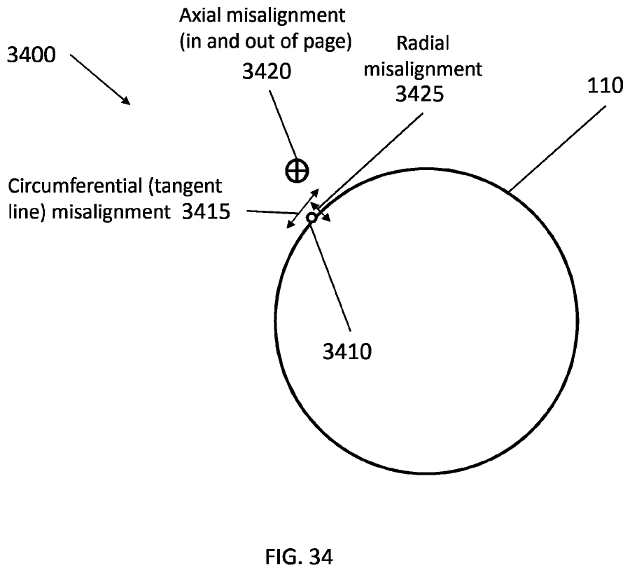

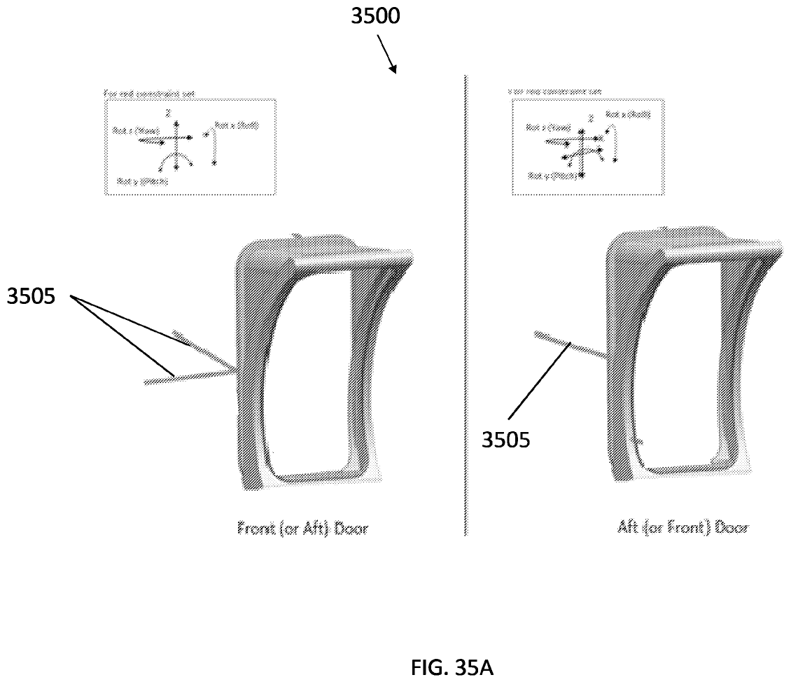

FIG. 34 schematically depicts 3400 a Pod with the different types of misalignment due to the loads on a Pod and variance accommodation in accordance with aspects of the disclosure. In embodiments, the nominal door load and the seal compression load per latch may be approximately 6 kN to approximately 26 kN depending on location of the catch 3410 on the Pod 110. Latch load, however, may not be applied purely radially due to misalignment between a latch and a catch from, for example, manufacturing tolerances, thermal, dP effects (misalignment vector cone). As shown in FIG. 34, the misalignment may include axial misalignment 3420 (that is misalignment in and out of page, in x-direction), circumferential (tangent line) misalignment 3415, and/or radial misalignment 3425. As discussed herein, if required, for example, a local load may deflect the latch arm to accommodate misalignment.

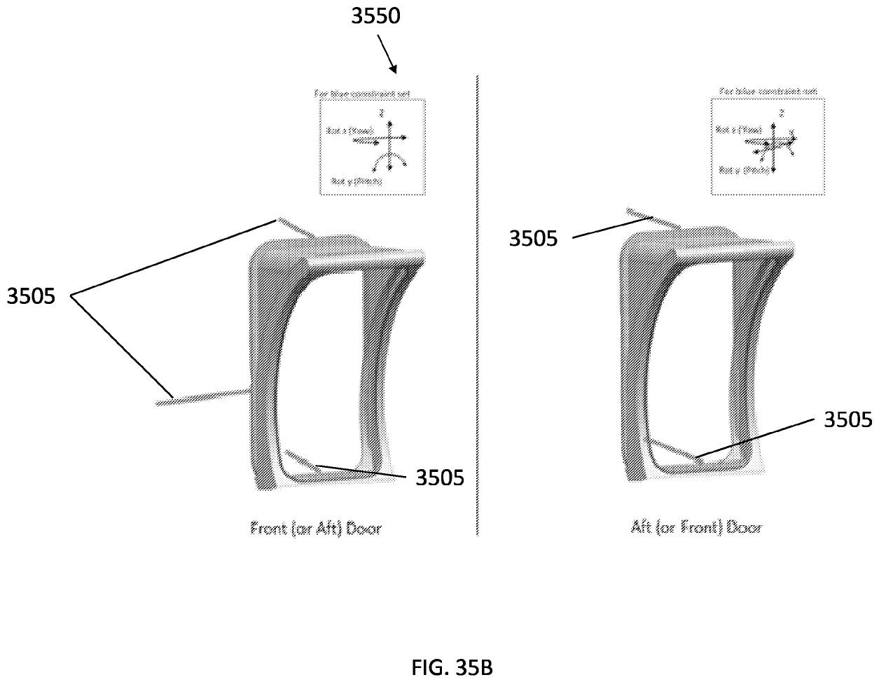

FIGS. 35A and 35B show exemplary schematic depictions of airdock door constraints to provide a rotational Z degree of freedom to accommodate for (or prevent) uneven gapping between the airdock and the Pod in accordance with aspects of the disclosure. Once the Pod and airdock are roughly aligned through the soft capture system, the airdock can engage some passive kinematic features that locally align the airdock door to the Pod door. Exemplary approaches to kinematically control this local alignment are shown in FIGS. 35A and 35B.

Hard capture is the process of connecting the airdock and the Pod to provide a structural path for the net pressure load of the door opening, and for reacting of the sealing loads. With an exemplary embodiment, there may be eighteen latches per door, and three kinematic mounts that define position of the airdock relative to the Pod. All of the latches should be able to sense engagement via either load or contact (or both). The latches also should provide a surface for the Pod to sense that they are engaged. In embodiments, the latches are non-backdrivable self-locking electromechanical actuators. The latches are not required to draw in the vehicle or bring systems into contact (which is performed by the soft capture system). Instead, the latches are actuated until engaged with their catches, and then hold position until the release sequence is commanded.

In the Pod reference frame, and when discussing Pod constraints, the airdock door is conceptualized to be one end of a two-force linkage. To that end, the airdock should be free in Z, Rot x (roll), Rot y (pitch), and Rot z (yaw). Additionally, one of the airdocks fixes the Pod in the longitudinal direction, while the other airdock allows motion in the same direction. With a first exemplary embodiment shown in FIG. 35A, the constraint lines (or supports) 3505 are for the front (or aft) airdock door and the aft (or front) airdock door are shown. These constrains can be achieved with use of v-bar alignment feature and/or ball contact alignment feature. For example, v-bar alignment features may be provided on the top, bottom and one side of each of the front and aft doors. These v-bar alignment features are operable to provide the constraints 3505, and exactly constrain the airdock door to the Pod with the three v-bar contacts on each airdock door.

Thus, with this example, the front (or the aft) door is constrained in the X and Y directions and the aft (or the front) door is constrained in the Y direction. The resulting degrees of freedom for both the front (or aft) airdock door and the aft (or front) airdock door are shown in the boxes. As shown, this arrangement provides degrees of freedom for the front (or aft) door in the Z direction, the rotational X (or roll) direction, the rotational Y (or pitch) direction, and rotational Z (or yaw) direction, and provides degrees of freedom for the aft (or front) door in the Z direction, the X direction, the rotational X (or roll) direction, the rotational Y (or pitch) direction, and rotational Z (or yaw) direction.

As shown in the alternative embodiment of FIG. 35B, it should be noted, however, that the rotational X (roll) degree of freedom may not be necessary if the seals can handle uneven gapping and latches can apply loads evenly with varying gap sizes. For example, as shown in FIG. 35B, the constraint lines (or supports) 3505 are for the front (or aft) airdock door and the aft (or front) airdock door are shown. These constrains can be achieved with use of v-bar alignment feature and/or ball contact alignment feature. For example, as shown in FIG. 35B, v-bar alignment features may be provided on each side of each of the front and aft doors. A cone-ball alignment feature may be provided at one side of each of the front and aft doors. These alignment features are operable to provide the constraints 3505, and constrain the airdock door to the Pod in all degrees of freedom. In accordance with aspects of the disclosure, the rotational X (roll) direction is fixed by both the hanger and airdock doors. The embodiment of FIG. 35B cannot accommodate rotation X alignment and so it relies on the seal to account for the misalignment but simplifies how the airdock structure is fixed.

Thus, with this example, the front (or the aft) door is constrained in the X and Y directions and the aft (or the front) door is constrained in the Y direction. The resulting degrees of freedom for both the front (or aft) airdock door and the aft (or front) airdock door are shown in the boxes. As shown, this arrangement provides degrees of freedom for the front (or aft) door in the Z direction, the rotational Y (or pitch) direction, and rotational Z (or yaw) direction, and provides degrees of freedom for the aft (or front) door in the Z direction, the X direction, the rotational Y (or pitch) direction, and rotational Z (or yaw) direction.

Expected operating conditions for an exemplary and non-limiting hard capture system include an operating force of 75 N, an actuation time of 0.5 second, a triangular acceleration profile, at a 10% duty cycle, a stroke of 25 mm, a holding force of 14 kN at 100% duty cycle. With these exemplary requirements, each latch draws approximately 2 W on average, and the entire latch system in a Pod Bay consumes 2 kWh over 15 cycles in an hour.

### System Environment

Aspects of embodiments of the present disclosure (e.g., control systems for a hard capture system) can be implemented by such special purpose hardware-based systems that perform the specified functions or acts, or combinations of special purpose hardware and computer instructions and/or software, as described above. The control systems may be implemented and executed from either a server, in a client server relationship, or they may run on a user workstation with operative information conveyed to the user workstation. In an embodiment, the software elements include firmware, resident software, microcode, etc.

As will be appreciated by one skilled in the art, aspects of the present disclosure may be embodied as a system, a method or a computer program product. Accordingly, aspects of embodiments of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure (e.g., control systems) may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, a magnetic storage device, a usb key, and/or a mobile phone.

In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network. This may include, for example, a local area network (LAN) or a wide area network (WAN), or the connection may be made to an external computer (for example, through the Internet using an Internet Service Provider). Additionally, in embodiments, the present disclosure may be embodied in a field programmable gate array (FPGA).

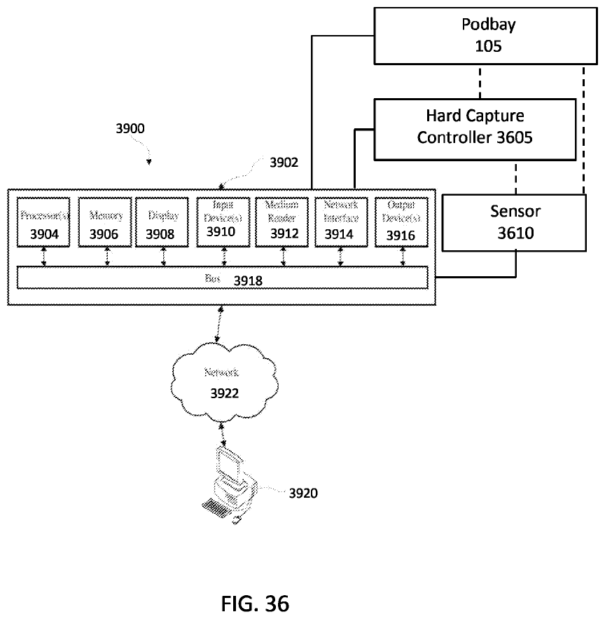

FIG. 36 is an exemplary system for use in accordance with the embodiments described herein. The system 3900 is generally shown and may include a computer system 3902, which is generally indicated. The computer system 3902 may operate as a standalone device or may be connected to other systems or peripheral devices. For example, the computer system 3902 may include, or be included within, any one or more computers, servers, systems, communication networks or cloud environment.

The computer system 3902 may operate in the capacity of a server in a network environment, or in the capacity of a client user computer in the network environment. The computer system 3902, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless telephone, a personal trusted device, a web appliance, or any other machine capable of executing a set of instructions (sequential or otherwise) that specify actions to be taken by that device. Further, while a single computer system 3902 is illustrated, additional embodiments may include any collection of systems or sub-systems that individually or jointly execute instructions or perform functions.

As illustrated in FIG. 36, the computer system 3902 may include at least one processor 3904, such as, for example, a central processing unit, a graphics processing unit, or both. The computer system 3902 may also include a computer memory 3906. The computer memory 3906 may include a static memory, a dynamic memory, or both. The computer memory 3906 may additionally or alternatively include a hard disk, random access memory, a cache, or any combination thereof. Of course, those skilled in the art appreciate that the computer memory 3906 may comprise any combination of known memories or a single storage.

As shown in FIG. 36, the computer system 3902 may include a computer display 3908, such as a liquid crystal display, an organic light emitting diode, a flat panel display, a solid state display, a cathode ray tube, a plasma display, or any other known display. The computer system 3902 may include at least one computer input device 3910, such as a keyboard, a remote control device having a wireless keypad, a microphone coupled to a speech recognition engine, a camera such as a video camera or still camera, a cursor control device, or any combination thereof. Those skilled in the art appreciate that various embodiments of the computer system 3902 may include multiple input devices 3910. Moreover, those skilled in the art further appreciate that the above-listed, exemplary input devices 3910 are not meant to be exhaustive and that the computer system 3902 may include any additional, or alternative, input devices 3910.

The computer system 3902 may also include a medium reader 3912 and a network interface 3914. Furthermore, the computer system 3902 may include any additional devices, components, parts, peripherals, hardware, software or any combination thereof which are commonly known and understood as being included with or within a computer system, such as, but not limited to, an output device 3916. The output device 3916 may be, but is not limited to, a speaker, an audio out, a video out, a remote control output, or any combination thereof. As shown in FIG. 36, the computer system 3902 may include communication and/or power connections to the Pod Bay 105, and a hard capture controller 3605 to control activation/deactivation of the hard capture system, in accordance with aspects of the disclosure. Additionally, as shown in FIG. 36, the computer system 3902 may include one or more sensors 3610 (e.g., positional sensors, GPS systems, magnetic sensors) that may provide data (e.g., positional data) to the hard capture controller 3605.

Furthermore, the aspects of the disclosure may take the form of a computer program product accessible from a computer-usable or computer-readable medium providing program code for use by or in connection with a computer or any instruction execution system. The software and/or computer program product can be implemented in the environment of FIG. 36. For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable storage medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disc-read/write (CD-R/W) and DVD.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

Accordingly, the present disclosure provides various systems, structures, methods, and apparatuses. Although the disclosure has been described with reference to several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular materials and embodiments, embodiments of the disclosure are not intended to be limited to the particulars disclosed; rather the disclosure extends to all functionally equivalent structures, methods, and uses such as are within the scope of the appended claims.

While the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk, tapes or other storage device to capture carrier wave signals such as a signal communicated over a transmission medium. Accordingly, the disclosure is considered to include any computer-readable medium or other equivalents and successor media, in which data or instructions may be stored.

While the specification describes particular embodiments of the present disclosure, those of ordinary skill can devise variations of the present disclosure without departing from the inventive concept.

One or more embodiments of the disclosure may be referred to herein, individually and/or collectively, by the term “invention” merely for convenience and without intending to voluntarily limit the scope of this application to any particular disclosure or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

While the disclosure has been described with reference to specific embodiments, those skilled in the art will understand that various changes may be made and equivalents may be substituted for elements thereof without departing from the true spirit and scope of the disclosure. While exemplary embodiments are described above, it is not intended that these embodiments describe all possible forms of the embodiments of the disclosure. Rather, the words used in the specification are words of description rather than limitation, and it is understood that various changes may be made without departing from the spirit and scope of the disclosure. In addition, modifications may be made without departing from the essential teachings of the disclosure. Furthermore, the features of various implementing embodiments may be combined to form further embodiments of the disclosure.

Insofar as the description above and the accompanying drawing disclose any additional subject matter that is not within the scope of the claims below, the embodiments are not dedicated to the public and the right to file one or more applications to claim such additional embodiments is reserved.

What is claimed is:

1. A hard capture system for securing a transportation vehicle to an airdock in a high-speed, low-pressure transportation system, wherein the airdock provides a pathway for off-loading and loading of passengers and/or cargo to the transportation vehicle, the hard capture system comprising:
a plurality of latches operable to maintain the transportation vehicle in a fixed position relative to the airdock.

2. The hard capture system of claim 1, wherein the transportation vehicle includes a corresponding plurality of catches to respectively receive the plurality of latches.

3. The hard capture system of claim 2, further comprising one or more sensors operable to detect engagement of the latches with the catches.

4. The hard capture system of claim 2, further comprising one or more sensors operable to detect engagement of the catches with the latches.

5. The hard capture system of claim 3, wherein the one or more sensors are load sensors and/or contact sensors operable to detect the engagement.

6. The hard capture system of claim 1, wherein each latch is non-back-drivable and/or self-locking.

7. The hard capture system of claim 2, wherein each latch is configured to extend and rotate to move into locking engagement with a respective catch.

8. The hard capture system of claim 2, wherein each latch is configured to pivot or swing to move into locking engagement with a respective catch.

9. The hard capture system of claim 2, wherein each latch is configured as a 4-bar linkage operable to slide and retract to move into locking engagement with a respective catch.

10. The hard capture system of claim 2, wherein each latch is configured as a 4-bar linkage operable to circumferentially swing and retract to move into locking engagement with a respective catch.

11. The hard capture system of claim 2, wherein each latch includes a track follower operable to move within a track actuator to circumferentially swing and retract the latch to move the latch into locking engagement with a respective catch.

12. The hard capture system of claim 2, wherein each latch includes a dual jaw operable for locking engagement with a respective catch.

13. The hard capture system of claim 1, wherein the hard capture system is operable to ensure sealing between the transportation vehicle and the airdock.

14. The hard capture system of claim 1, wherein the latches are configured to react to a door plug load to hold the transportation vehicle aligned relative to the airdock in at least in a y-direction.

15. The hard capture system of claim 1, wherein the latches provides a structural path from the transportation vehicle to the airdock for a net pressure load of door opening and for reacting of sealing loads.

16. The hard capture system of claim 15, further comprising at least one seal arranged between the airdock and the transportation vehicle, wherein the latches provide a compression load to the at least one seal.

17. A method of operating a hard capture system for securing a transportation vehicle to an airdock in a high-speed, low-pressure transportation system, wherein the airdock provides a pathway for off-loading and loading of passengers and/or cargo to the transportation vehicle, the method comprising:
engaging a plurality of latches arranged on the airdock with a corresponding plurality of catches arranged on the transportation vehicle to maintain the transportation vehicle in a fixed position relative to the airdock.

18. The method of claim 17, further comprising using one or more sensors to detect engagement of the latches with the catches.

19. The method of claim 17, wherein when the latches are engaged with the catches, the latches provides a structural path from the transportation vehicle to the airdock, the method further comprising:
reacting a net pressure load of door opening via the structural path, and
reacting sealing loads via the structural path.

20. The method of claim 17, further comprising providing a compression load to at least one seal arranged between the airdock and the transportation vehicle.
